(19) United States
(12) Patent Application Publication
(10) Pub. No.: US 2016/0239117 A1
(43) Pub. Date: Aug. 18, 2016

(54) LAYERED BODY FOR TRANSPARENT CONDUCTIVE MEMBER, TRANSFER MATERIAL, TRANSPARENT CONDUCTIVE MEMBER, TOUCH PANEL AND PROCESS FOR PRODUCING SAME, AND TOUCH PANEL DISPLAY DEVICE

(71) Applicant: FUJIFILM Corporation, Tokyo (JP)

(72) Inventors: Hideyuki NAKAMURA, Shizuoka (JP); Takeshi ANDO, Shizuoka (JP)

(73) Assignee: FUJIFILM Corporation, Tokyo (JP)

(21) Appl. No.: 14/997,581

(22) Filed: Jan. 18, 2016

(30) Foreign Application Priority Data
Feb. 18, 2015 (JP) 2015-029959

(51) Int. Cl. G06F 3/041

(52) U.S. Cl. CPC G06F 3/041; G06F 2203/04103

(57) ABSTRACT

It is an object of the present invention to provide a layered body for a transparent conductive member having low resistance, high transmittance, and excellent crack resistance, a transfer material having the layered body for a transparent conductive member, a transparent conductive member formed using the layered body for a transparent conductive member, a touch panel and a touch panel display device, and a process for producing a touch panel using the transfer material.

A layered body for a transparent conductive member comprises, in order, a first layer, a metal layer, and a second layer, the first and second layers each comprising an organic resin and a titanium compound and/or a zirconium compound, the first and second layers each having a refractive index of 1.6 to 2.0, the first and second layers each having an average thickness of 10 to 100 nm, the metal layer comprising silver and/or copper.

### CROSS-REFERENCE TO RELATED APPLICATION

The present application claims a Paris Convention priority to Japanese Patent Application No. 2015-029959 filed on Feb. 18, 2015. The contents of the basic application are incorporated herein by reference in their entirety.

### TECHNICAL FIELD

The present invention relates to a layered body for a transparent conductive member, a transfer material, a transparent conductive member, a touch panel and a process for producing same, and a touch panel display device.

### BACKGROUND ART

In achieving higher performance for a transparent conductive film, achieving lower resistance is an important object. Instead of an oxide-based transparent conductive film such as ITO (indium-doped tin oxide), the development of a low-resistance transparent conductive film formed by nano layering of a metal and an alloy/oxide such as Ag/ITO has been carried out.

For example, JP-A-2014-69572 (JP-A denotes a Japanese unexamined patent application publication) describes a transparent conductive substrate comprising a substrate, a transparent conductive layer formed above the substrate and comprising a pattern part where it is coated with a transparent conductive film and a non-pattern part where the substrate is exposed, and a polymer resin layer formed from a resin having a refractive index of 1.4 to 1.6, filling the non-pattern part, formed above the transparent conductive layer, and having a thickness from the pattern part of 1 to 1000 μm, the transparent conductive film comprising a first thin film formed above the substrate and having a refractive index of 2.1 to 2.7 and a thickness of 30 to 50 nm, a metal thin film formed above the first thin film and having a thickness of 5 to 15 nm, and a second thin film formed above the metal thin film and having a refractive index of 2.1 to 2.7 and a thickness of 30 to 50 nm.

Furthermore, J. Vac. Soc. Jpn., Vol. 56, No. 11, 2013, 466-468 describes a low resistance transparent conductive film formed by nano layering of AlN/Ag/AlN.

### SUMMARY OF THE INVENTION

### Problems to be Solved by the Invention

It is an object of the present invention to provide a layered body for a transparent conductive member having low resistance, high transmittance, and excellent crack resistance, a transfer material having the layered body for a transparent conductive member, a transparent conductive member formed using the layered body for a transparent conductive member, a touch panel and a touch panel display device, and a process for producing a touch panel using the transfer material.

### Means for Solving the Problems

The object of the present invention has been attained by means described in <1> or <10> to <14> below. They are described below together with <2> to <9>, which are preferred embodiments.

### Claims

<1> A layered body for a transparent conductive member comprising, in order, a first layer, a metal layer, and a second layer, the first and second layers each comprising an organic resin and, as Component A, at least one type selected from the group consisting of a1 to a3 below, the first and second layers each having a refractive index of 1.6 to 2.0 for light having a wavelength of 550 nm, the first and second layers each having an average thickness of 10 to 100 nm, the metal layer comprising silver and/or copper, and the metal layer having an average thickness of 5 to 50 nm

a1: an alkoxy group-containing titanium compound and/or zirconium compound,

a2: a titanoxane, zirconoxane, and/or titanoxane-zirconoxane condensation product having at least one alkoxy group directly connected to a titanium atom or a zirconium atom,

a3: a titanium atom- and/or zirconium atom-containing metal oxide,

<2> the layered body for a transparent conductive member according to <1>, wherein it has a transmittance for light having a wavelength of 550 nm of at least 60%,
<3> the layered body for a transparent conductive member according to <1> or <2>, wherein Component A in the first and second layers has a content by mass of at least 20 mass % but no greater than 70 mass %,
<4> the layered body for a transparent conductive member according to any one of <1> to <3>, wherein the organic resin comprises a resin having a fluorene ring structure,
<5> the layered body for a transparent conductive member according to any one of <1> to <4>, wherein the organic resin comprises an acrylic resin,
<6> the layered body for a transparent conductive member according to any one of <1> to <5>, wherein the metal layer comprises silver,
<7> the layered body for a transparent conductive member according to any one of <1> to <6>, wherein the metal layer comprises a silver alloy,
<8> the layered body for a transparent conductive member according to any one of <1> to <7>, wherein the first and second layers each comprise at least a1 as Component A,
<9> the layered body for a transparent conductive member according to any one of <1> to <7>, wherein the first and second layers each comprise at least a3 as Component A,
<10> a transfer material comprising the layered body for a transparent conductive member according to any one of <1> to <9> above a temporary support,
<11> a process for producing a touch panel, comprising forming a touch electrode using the transfer material according to <10>,
<12> a transparent conductive member comprising a cured material formed by curing the layered body for a transparent conductive member according to any one of <1> to <9>,
<13> a touch panel comprising the transparent conductive member according to <12>, and
<14> a touch panel display device comprising the transparent conductive member according to <12>.

### MODES FOR CARRYING OUT THE INVENTION

The content of the present invention is explained in detail below. The explanation of the constituent features given below is based on representative embodiments of the present invention, but the present invention should not be construed as being limited to such embodiments. In the present specification, ‘to’ is used to mean that the numerical values given before and after it are included as a lower limit value and an upper limit value. Furthermore, an organic EL device in the present invention means an organic electroluminescence device.

With regard to the notation of a group (atomic group) in the present specification, a notation that does not indicate whether it is substituted or unsubstituted includes one without a substituent as well as one with a substituent. For example, an ‘alkyl group’ includes an alkyl group without a substituent (unsubstituted alkyl group) as well as an alkyl group with a substituent (substituted alkyl group).

Furthermore, a chemical structural formula in the present specification might be given using a simplified structural formula in which hydrogen atoms are omitted.

In addition, in the present specification, “(meth)acrylate” denotes acrylate and methacrylate, “(meth)acrylic” denotes acrylic and methacrylic, and “(meth)acryloyl” denotes acryloyl and methacryloyl.

In the present invention, ‘at least one type selected from the group consisting of a1 to a3’, etc. is also called simply ‘Component A’, etc.

Furthermore, in the present invention, ‘mass %’ and ‘wt %’ have the same meaning, and ‘parts by mass’ and ‘parts by weight’ have the same meaning.

Moreover, in the present invention, a combination of two or more preferred embodiments is a more preferred embodiment.

The weight-average molecular weight and number-average molecular weight of a resin, a titanoxane, a zirconoxane, and a titanoxane-zirconoxane condensation product in the present invention are measured using a gel permeation chromatography (GPC) method.

### (Layered Body for Transparent Conductive Member)

The layered body for a transparent conductive member of the present invention comprises, in order, a first layer, a metal layer, and a second layer, the first and second layers each comprising an organic resin and, as Component A, at least one type selected from the group consisting of a1 to a3 below, the first and second layers each having a refractive index of 1.6 to 2.0 for light having a wavelength of 550 nm, the first and second layers each having an average thickness of 10 to 100 nm, the metal layer comprising silver and/or copper, and the metal layer having an average thickness of 5 to 50 nm.

a1: an alkoxy group-containing titanium compound and/or zirconium compound,

a2: a titanoxane, zirconoxane, and/or titanoxane-zirconoxane condensation product having at least one alkoxy group directly connected to a titanium atom or a zirconium atom,

a3: a titanium atom- and/or zirconium atom-containing metal oxide.

In J. Vac. Soc. Jpn., Vol. 56, No. 11, 2013, 466-468, an AlN/Ag/AlN nano-layered film is produced under various conditions on a polyethylene terephthalate (PET) film by combining Ag as a metal and, as a dielectric, an AlN thin film, which has a large refractive index and high transmittance in the visible region compared with ITO, etc., and the relationship between production conditions and electrical characteristics and optical characteristics are studied.

This time, as a result of an intensive investigation by the present inventors, it has been found that a layered body for a transparent conductive member having low resistance, high transmittance, and excellent crack resistance can be obtained by forming a sandwich structure of a metal layer having a specific thickness with an organic/inorganic composite high-refractive-index material having a specific thickness, and the present invention has thus been accomplished.

The detailed mechanism by which the effects are exhibited is unknown, but it is surmised that low resistance and high transmittance can be achieved by setting each layer at a specific thickness, and high transmittance as well as flexibility and excellent crack resistance can be obtained by forming the first and second layers from an organic/inorganic composite layer having a specific formulation.

Furthermore, the first and second layers of the layered body for a transparent conductive member of the present invention may be easily formed by a coating method, which is inexpensive compared with a vapor deposition method, and the layered body for a transparent conductive member of the present invention is excellent in terms of cost.

The higher the transmittance for visible light of the layered body for a transparent conductive member of the present invention, the better from the viewpoint of improvement of screen brightness when used in a sensor electrode of a display device-equipped touch panel. Specifically, the transmittance for light having a wavelength of 550 nm is preferably at least 60%, more preferably at least 70%, yet more preferably at least 80%, and particularly preferably at least 90%. The upper limit value for the transmittance is 100%.

### <Metal Layer>

The layered body for a transparent conductive member of the present invention comprises, in order, a first layer, a metal layer, and a second layer, the metal layer comprising silver and/or copper, and the metal layer having an average thickness of 5 to 50 nm.

The material of the metal layer is preferably silver, copper, or an alloy containing such a metal, more preferably silver or a silver alloy, yet more preferably a silver alloy, and particularly preferably a silver-palladium alloy. With this embodiment, even with a thin film of 5 to 50 nm, it is possible to easily form a uniform layer, and the resistance can be made lower.

An element that may be contained in the alloy is not particularly limited, but is preferably a transition metal element, more preferably a transition metal element of Group 9 to 14, yet more preferably palladium, gold, nickel, platinum, zinc, indium, tin, and/or lead, and particularly preferably palladium.

Furthermore, the total content of silver and copper in the metal layer is preferably at least 50 mass %, more preferably at least 90 mass %, yet more preferably at least 95 mass %, and particularly preferably at least 97 mass %. The upper limit value for the total content is 100 mass %.

The average thickness of the metal layer is 5 to 50 nm, preferably 5 to 30 nm, more preferably 5 to 20 nm, and yet more preferably 5 to 15 nm. With this embodiment, a layered body for a transparent conductive member having low resistance but higher transmittance can be obtained. In the present invention, the average thickness of each layer is the average value of the thickness of the layer measured at 1 cm intervals within the plane in the longitudinal direction and the width direction with respect to the direction of coating. Examples of a method for measuring the thickness include a method in which a cross-section of the layered body for a transparent conductive member is examined using a scanning electron microscope.

### <First and Second Layers>

The layered body for a transparent conductive member of the present invention comprises, in order, a first layer, a metal layer, and a second layer, the first and second layers each comprise as Component A at least one type selected from the group consisting of a1 to a3 above, and an organic resin, the first and second layers each having a refractive index for light having a wavelength of 550 nm of 1.6 to 2.0, and the first and second layers each having an average thickness of 10 to 100 nm.

As described later, the layered body for a transparent conductive member of the present invention may have a structure other than the first layer, the metal layer, and the second layer, but it is preferable that the first layer and the metal layer as well as the metal layer and the second layer are in direct contact with each other.

Furthermore, the first layer and the second layer in the layered body for a transparent conductive member of the present invention are preferably each a transparent layer.

The refractive index for light having a wavelength of 550 nm of each of the first and second layers is 1.6 to 2.0, preferably 1.6 to 1.95, more preferably 1.62 to 1.90, and yet more preferably 1.70 to 1.85. When in this range, the transmittance is higher, and the crack resistance is better.

As a method for measuring refractive index, the refractive index at a wavelength of 550 nm may be measured at 25° C. using a VUV-VASE ellipsometer (J. A. Wollam Co., Inc., Japan). Although the refractive index of the first and second layers varies little with change in temperature, it is preferably measured at 25° C.

Moreover, the refractive index for light having a wavelength of 550 nm of the first layer and the refractive index for light having a wavelength of 550 nm of the second layer may be identical to or different from each other, but it is preferable that the refractive index for light having a wavelength of 550 nm of the first layer is 0.9 to 1.1 times the refractive index for light having a wavelength of 550 nm of the second layer.

The average thickness of each of the first and second layers is 10 to 100 nm, more preferably 20 to 90 nm, more preferably 25 to 75 nm, and yet more preferably 30 to 60 nm. When in this range, the transmittance is higher, and the crack resistance is better.

Furthermore, the average thickness of the first layer and the average thickness of the second layer may be identical to or different from each other, but it is preferable that the average thickness of the first layer is 0.8 to 1.2 times the average thickness of the second layer.

Component A: At Least One Type Selected from Group Consisting of a1 to a3

With regard to the layered body for a transparent conductive member of the present invention, the first and second layers each comprise at least one type selected from the group consisting of a1 to a3 below as Component A.

a1: alkoxy group-containing titanium compound and/or zirconium compound,

a2: titanoxane, zirconoxane and/or titanoxane-zirconoxane condensation product having at least one alkoxy group directly connected to a titanium atom or a zirconium atom,

a3: titanium atom- and/or zirconium atom-containing metal oxide.

Component A may comprise one type of a1 to a3 on its own or two or more types thereof.

When the first and/or second layer comprises a1 as Component A, it is preferable for it to simultaneously comprise a component corresponding to an a2 that is a condensate of said a1.

Among them, it is preferable for the first and second layers to each comprise a3, it is more preferable for them to comprise one type of particles selected from the group consisting of titanium oxide particles, zirconium oxide particles, and titanium atom- and/or zirconium atom-containing composite oxide particles, and it is yet more preferable for them to comprise titanium oxide particles. With this embodiment, the transmittance is higher, and the crack resistance is better.

The content (mass content) of Component A in the first and second layers is preferably 15 to 80 mass %, more preferably 20 to 70 mass %, and yet more preferably 40 to 65 mass %. When in this range, the transmittance is higher, and the crack resistance is better.

Component A is preferably selected from the group consisting of a titanium compound, a titanoxane, and titanium oxide from the viewpoint of cost and refractive index, or is preferably selected from the group consisting of a zirconium compound, a zirconoxane, and zirconium oxide from the viewpoint of low temperature curability, cure rate, and stability.

a1: Alkoxy Group-Containing Titanium Compound and/or Zirconium Compound

Examples of the alkoxy group-containing titanium compound and alkoxy group-containing zirconium compound (a1) include a titanium monoalkoxide, a titanium dialkoxide, a titanium trialkoxide, a titanium tetraalkoxide, a zirconium monoalkoxide, a zirconium dialkoxide, a zirconium trialkoxide, and a zirconium tetraalkoxide. Among them a titanium tetraalkoxide and a zirconium tetraalkoxide are preferable.

The titanium tetraalkoxide is preferably a titanium tetraalkoxide represented by Formula a1-1 below from the viewpoint of film physical properties.

The zirconium tetraalkoxide is preferably a zirconium tetraalkoxide represented by Formula a1-2 below from the viewpoint of film physical properties.

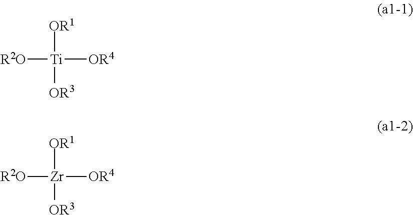

In Formula a1-1 and Formula a1-2, R¹ to R⁴ independently denote an alkyl group having 1 to 18 carbons, an aryl group having 6 to 18 carbons, or an aralkyl group having 7 to 18 carbons.

Examples of the titanium tetraalkoxide represented by Formula a1-1 include titanium tetramethoxide, titanium tetraethoxide, titanium tetra-n-propoxide, titanium tetraisopropoxide, titanium tetra-n-butoxide, titanium tetraisobutoxide, titanium diisopropoxydi-n-butoxide, titanium di-t-butoxydiisopropoxide, titanium tetra-t-butoxide, titanium tetraisooctyloxide, and a titanium tetrastearylalkoxide.

Specific examples of the zirconium tetraalkoxide represented by Formula a1-2 include, but are not limited to, zirconium tetramethoxide, zirconium tetraethoxide, zirconium tetra-n-propoxide, zirconium tetraisopropoxide, zirconium tetra-n-butoxide, zirconium tetraisobutoxide, zirconium diisopropoxydi-n-butoxide, zirconium di-t-butoxydiisopropoxide, zirconium tetra-t-butoxide, zirconium tetraisooctyloxide, and a zirconium tetrastearylalkoxide.

a2: Titanoxane, Zirconoxane, and/or Titanoxane-Zirconoxane Condensation product having at least one alkoxy group directly connected to titanium atom or zirconium atom

The titanoxane is also called a polytitanoxane and is a compound having two or more Ti—O—Ti bonds.

The zirconoxane is also called a polyzirconoxane and is a compound having two or more Zr—O—Zr bonds.

The titanoxane is preferably a titanoxane represented by Formula a2-1 below from the viewpoint of film physical properties.

Furthermore, the zirconoxane is preferably a zirconoxane represented by Formula a2-2 below from the viewpoint of film physical properties.

Ti_{α}O_{β}(OR)_{γ} (a2-1)

Zr_{α}O_{β}(OR)_{γ} (a2-2)

In Formula a2-1 and Formula a2-2, the Rs independently denote a hydrogen atom, an alkyl group having 1 to 18 carbons, an aryl group having 6 to 18 carbons, or an aralkyl group having 7 to 18 carbons, α, β, and γ satisfy conditions a′ to c′ below, a denotes a positive integer, and β and γ denote a positive number.
a′: 200≧α≧2,
b′: 1.9α≧β≧1.0α,
c′: γ=4α−2β

The titanoxane, zirconoxane, and titanoxane-zirconoxane condensation product denoted by a2 may be one having a single formula or a mixture of two or more types.

a3: Titanium Atom- and/or Zirconium Atom-Containing Metal Oxide

The titanium atom- and/or zirconium atom-containing composite oxide is preferably titanium oxide, a titanium composite oxide, zirconium oxide, or a zirconium composite oxide, more preferably titanium oxide, a titanium composite oxide, or zirconium oxide, yet more preferably titanium oxide or zirconium oxide, and particularly preferably titanium oxide.

The titanium oxide is particularly preferably a rutile type, which has a high refractive index.

Furthermore, a3 preferably comprises metal oxide particles.

As a3, commercial products may be used, and examples include, as titanium oxide particles, the TTO series (TTO-51 (A), TTO-51 (C), etc.), TTO-S, and the V series (TTO-S-1, TTO-S-2, TTO-V-3, etc.) manufactured by Ishihara Sangyo Kaisha Ltd., the MT series manufactured by Tayca Corporation (MT-01, MT-05, etc.), as tin oxide-titanium oxide composite particles Optolake TR-502 and Optolake TR-504 (both from JGC C & C), as silicon oxide-titanium oxide composite particles Optolake TR-503, Optolake TR-513, Optolake TR-520, Optolake TR-521, and Optolake TR-527 (all from JGC C & C), zirconium oxide particles (Kojundo Chemical Laboratory Co., Ltd.), and tin oxide-zirconium oxide composite particles (JGC C & C).

Furthermore, a3 preferably comprises metal oxide particles.

From the viewpoint of transparency, the average primary particle size of a3 is preferably 1 to 200 nm, more preferably 3 to 80 nm, and particularly preferably 5 to 50 nm. The average primary particle size of particles referred to here means the arithmetic average of the particle size of any 200 particles measured using an electron microscope. When the shape of the particles is not spherical, the size corresponds to the longest side.

Moreover, a3 may be supplied for use as a dispersion prepared by mixing and dispersing in an appropriate dispersant and solvent using a mixer such as a ball mill or a rod mill.

### Organic Resin

With regard to the layered body for a transparent conductive member of the present invention, the first and second layers each comprise an organic resin.

The organic resin is not particularly limited; a known resin may be used, and examples thereof include an acrylic resin, an epoxy resin, and a urethane resin, but in particular it preferably comprises at least an acrylic resin. With this embodiment, the transmittance is higher, and the crack resistance is better.

The organic resin preferably has a fluorene ring structure as described below. Due to it having a fluorene ring structure, the transparency becomes higher.

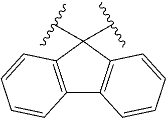 [SMILES: *C1(*)c2ccccc2-c2ccccc21]

The fluorene ring structure may have a substituent on the aromatic ring, and the substituents may be bonded to each other to form an alicyclic or aromatic ring.

Preferred examples of the substituent include a halogen atom, an alkyl group, an aryl group, an alkoxy group, an aryloxy group, an alkylthio group, and an arylthio group, more preferred examples include a halogen atom, an alkyl group, and an alkoxy group, and yet more preferred examples include an alkyl group.

The organic resin may be for example a first and second layer-forming composition itself, which is described layer, one that is dried, or one that is cured and thermally treated, but is preferably a resin formed by curing the first and second layer-forming composition, which is described later, and is more preferably a resin formed by curing and further thermally treating the first and second layer-forming composition, which is described later.

The content of the organic resin in the first and second layers is preferably 20 to 85 mass %, more preferably 30 to 80 mass %, and yet more preferably 35 to 60 mass %. When in this range, the transmittance is higher, and the crack resistance is better.

### Support

The layered body for a transparent conductive member of the present invention may comprise a support.

When it comprises a support, the layered body for a transparent conductive member of the present invention preferably comprises, in order, a first layer, a metal layer, a second layer, and a support.

Examples of a material for the support include an inorganic material, a resin, and a resin composite material.

Examples of the inorganic material include glass, quartz, silicon, silicon nitride, and a composite substrate formed by vapor deposition of molybdenum, titanium, aluminum, copper, etc. on such a substrate.

Examples of the resin include synthetic resins such as polybutylene terephthalate, polyethylene terephthalate, polyethylene naphthalate, polybutylene naphthalate, polystyrene, polycarbonate, polysulfone, polyether sulfone, polyallylate, an allyldiglycolcarbonate resin, polyamide, polyimide, polyamide-imide, polyetherimide, polybenzazole, polyphenylene sulfide, a polycycloolefin, a norbornene resin, a fluorine resin such as polychlorotrifluoroethylene, a liquid crystal polymer, an acrylic resin, an epoxy resin, a silicone resin, an ionomer resin, a cyanate resin, a crosslinked fumaric acid diester, a cyclic polyolefin, an aromatic ether resin, a maleimide-olefin copolymer, cellulose, and an episulfide resin.

These supports are not often used in their ‘as is’ configuration, and are usually formed into a multilayer structure such as for example in a thin film transistor (TFT) device according to the configuration of the final product.

Among them, a transparent support is preferable, a polyester film or a glass substrate is more preferable, and a polyethylene terephthalate (PET) film or a glass substrate is yet more preferable.

The thickness of the support is not particularly limited but is preferably 0.5 μm to 2 mm.

The support may be a temporary support in a transfer material that is described later.

The layered body for a transparent conductive member of the present invention may comprise a known layer in addition to the above layers. Examples include a refractive index-adjusting layer, a protective layer, an insulating layer, an adhesion layer, and a pressure-sensitive adhesion layer.

### {First and Second Layer-Forming Composition}

The first and second layers in the layered body for a transparent conductive member of the present invention are each preferably formed from a first and second layer-forming composition.

The first and second layer-forming composition is preferably a curable corn position.

Furthermore, the first and second layer-forming composition is preferably a photosensitive composition, and more preferably a positive-working photosensitive composition or a negative-working photosensitive composition.

Component A: At Least One Type Selected from the Group Consisting of a1 to a3

The first and second layer-forming composition comprises as Component A at least one type selected from the group consisting of a1 to a3 below.

a1: an alkoxy group-containing titanium compound and/or zirconium compound,

a2: a titanoxane, zirconoxane and/or titanoxane-zirconoxane condensation product having at least one alkoxy group directly connected to a titanium atom or a zirconium atom,

a3: a titanium atom- and/or zirconium atom-containing metal oxide.

Preferred embodiments of Component A are the same as those of Component A described above.

The content of Component A is preferably 15 to 80 mass % relative to the total solids content of the photosensitive composition, more preferably 20 to 70 mass %, and yet more preferably 40 to 65 mass %. The ‘solids content’ in the photosensitive composition denotes components excluding volatile components such as solvent. Needless to say the solids content may be not only for a solid but also for a liquid.

### Component B: Fluorene Compound

The first and second layer-forming composition preferably comprises a fluorene compound, and more preferably comprises a reactive group-containing fluorene compound. Due to a fluorene compound being used, it is possible to easily introduce a fluorene ring structure into the organic resin.

Furthermore, a fluorene ring structure may be introduced into the organic resin by copolymerization of a monomer having a fluorene ring with a resin such as a binder polymer.

Preferred examples of the reactive group-containing fluorene compound include compounds represented by Formula I below.

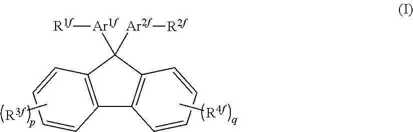

In Formula I, Ar^{1f} and Ar^{2f} independently denote an arylene group, R^{1f} and R^{2f} independently denote a hydroxy group, a carboxy group, an alkoxy group, or a monovalent organic group containing at least one type of group selected from the group consisting of a hydroxy group, a carboxy group, an epoxy group, and an oxetanyl group, at least one of R^{1f} and R^{2f} is a hydroxy group, a carboxy group, or a monovalent organic group containing at least one type of group selected from the group consisting of a hydroxy group, a carboxy group, an epoxy group, and an oxetanyl group, R^{3f} and R^{4f} independently denote a monovalent substituent, p and q independently denote an integer of 0 to 4, and different R^{3f}s and different R^{4f}s may be bonded to each other to form an alicyclic or aromatic ring.

From the viewpoint of synthesis and dielectric constant, Ar^{1f} and Ar^{2f} are preferably independently a divalent aromatic hydrocarbon group, more preferably a phenylene group or a naphthylene group, yet more preferably a 1,4-phenylene group or a 2,6-naphthylene group, and particularly preferably a 1,4-phenylene group. From the viewpoint of refractive index, Ar^{1f} and Ar^{2f} are preferably independently a naphthylene group, and more preferably a 2,6-naphthylene group.

From the viewpoint of synthesis and dielectric constant, Ar^{1f} and Ar^{2f} are preferably the same group.

Ar^{1f} and Ar^{2f} may independently optionally have a substituent on an aromatic ring.

Preferred examples of the substituent include a halogen atom, an alkyl group, an alkenyl group, an aryl group, an alkoxy group, an aryloxy group, an alkylthio group, and an arylthio group, more preferred examples include a halogen atom, an alkyl group, and an aryl group, and yet more preferred examples include an alkyl group and an aryl group.

The substituents may be bonded to each other to form an alicyclic or aromatic ring.

R^{1f} and R^{2f} independently denote a hydroxy group, a carboxy group, an alkoxy group, or a monovalent organic group containing at least one type of group selected from the group consisting of a hydroxy group, a carboxy group, an epoxy group, and an oxetanyl group, and at least one of R^{1f} and R^{2f} is a hydroxy group, a carboxy group, or a monovalent organic group containing at least one type of group selected from the group consisting of a hydroxy group, a carboxy group, an epoxy group, and an oxetanyl group.

From the viewpoint of refractive index and dielectric constant, R^{1f} and R^{2f} are preferably independently a hydroxy group, a carboxy group, or a monovalent organic group containing at least one type of group selected from the group consisting of a hydroxy group, a carboxy group, an epoxy group, and an oxetanyl group, more preferably a hydroxy group or a monovalent organic group containing at least one type of group selected from the group consisting of a hydroxy group, an epoxy group, and an oxetanyl group, yet more preferably a monovalent organic group containing at least one type of group selected from the group consisting of an epoxy group and an oxetanyl group, and particularly preferably an epoxy group-containing monovalent organic group.

From the viewpoint of sensitivity, R^{1f} and R^{2f} are preferably hydroxy groups or hydroxy group-containing monovalent organic groups, and from the viewpoint of transparency they are preferably epoxy group- or oxetanyl group-containing monovalent organic groups.

Moreover, from the viewpoint of synthesis, R^{1f} and R^{2f} are particularly preferably the same group.

The monovalent organic group, denoted by R^{1f} and R^{2f}, containing at least one type of group selected from the group consisting of a hydroxy group, a carboxy group, an epoxy group, and an oxetanyl group is preferably a monovalent organic group containing at a terminal at least one type of group selected from the group consisting of a hydroxy group, a carboxy group, an epoxy group, and an oxetanyl group.

A partial structure other than a hydroxy group, a carboxy group, an epoxy group, and an oxetanyl group in the monovalent organic group is preferably a structure such as an alkylene group, an ether bond, a thioether bond, a carbonyl group, an amide bond, or a combination thereof.

The monovalent organic group is preferably an ether bond-, alkyleneoxy group-, or polyalkyleneoxy group-containing group, and more preferably has an ether bond or an alkyleneoxy group.

Furthermore, from the viewpoint of refractive index and dielectric constant, R^{1f} and R^{2f} are preferably independently a hydroxy group, a glycidyloxy group, a 3-alkyl-3-oxetanylmethyloxy group, a glycidyloxyalkyleneoxy group, or a glycidyloxypolyalkyleneoxy group, more preferably a hydroxy group, a glycidyloxy group, or a glycidyloxyalkyleneoxy group, yet more preferably a glycidyloxy group or a glycidyloxyalkyleneoxy group, and particularly preferably a glycidyloxyalkyleneoxy group.

R^{1f} and R^{4f} independently denote a monovalent substituent.

Preferred examples of the monovalent substituent denoted by R^{3f} and R^{4f} include a halogen atom, an alkyl group, an aryl group, an alkoxy group, an aryloxy group, an alkylthio group, and an arylthio group, more preferred examples include a halogen atom, an alkyl group, and an alkoxy group, and yet more preferable examples include an alkyl group.

p and q independently denote an integer of 0 to 4, preferably an integer of 0 to 2, more preferably 0 or 2, and particularly preferably 0.

Furthermore, different R^{3f}s or different R^{4f}s may be bonded to each other to form an alicyclic or aromatic ring. When the ring is formed, it is preferable to form an aromatic ring, and it is more preferable to form a ring below together with the fluorene ring.

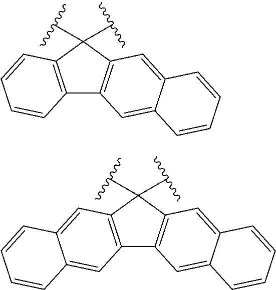

The compound represented by Formula I preferably has 4 to 8 benzene rings, more preferably 5 to 8, and yet more preferably 6 to 8. With this embodiment, the refractive index is better. For example, a naphthalene ring has two benzene rings.

From the viewpoint of solubility in a developer and optical characteristics, the molecular weight of the compound represented by Formula I is preferably less than 1,000, more preferably at least 400 but less than 1,000, yet more preferably 400 to 800, and particularly preferably 400 to 600.

Specific examples of the compound represented by Formula I include a 9,9-bis(glycidyloxyalkoxy-alkylphenyl)fluorene {a 9,9-bis(glycidyloxy C2-4 alkoxy-mono or di C1-4 alkylphenyl)fluorene such as for example 9,9-bis[4-(2-glycidyloxyethoxy)-3-methylphenyl]fluorene or 9,9-bis[4-(2-glycidyloxyethoxy)-3,5-dimethylphenyl]fluorene}, a 9,9-bis(glycidyloxydialkoxy-alkylphenyl)fluorene {a 9,9-bis(glycidyloxydi C2-4 alkoxy-mono or di C1-4 alkylphenyl)fluorene such as for example 9,9-bis{4-[2-(2-glycidyloxyethoxy)ethoxy]-3-methylphenyl}fluorene or 9,9-bis{4-[2-(2-glycidyloxyethoxy)ethoxy]-3,5-dimethylphenyl}fluorene}, a 9,9-bis(glycidyloxy alkoxynaphthyl)fluorene {a 9,9-bis(glycidyloxy C2-4 alkoxynaphthyl)fluorene such as for example 9,9-bis[6-(2-glycidyloxyethoxy)-2-naphthyl]fluorene, 9,9-bis[5-(2-glycidyloxyethoxy)-1-naphthyl]fluorene, or 9,9-bis[6-(2-glycidyloxypropoxy)-2-naphthyl]fluorene}, a 9,9-bis(glycidyloxydialkoxynaphthyl)fluorene {a 9,9-bis(glycidyloxydi C2-4 alkoxynaphthyl)fluorene such as for example 9,9-bis{6-[2-(2-glycidyloxyethoxy)ethoxy]-2-naphthyl}fluorene, 9,9-bis{5-[2-(2-glycidyloxyethoxy)ethoxy]-1-naphthyl}fluorene, or 9,9-bis{6-[2-(2-glycidyloxypropoxy)propoxy]-2-naphthyl}fluorene}, and a compound in which the glycidyloxy group is replaced with a hydroxy group, a carboxy group, or a 3-alkyl-3-oxetanylmethyloxy group. C1-4 alkyl, etc. means an alkyl having 1 to 4 carbons.

With regard to the fluorene compound, one type may be used on its own or two or more types may be used in combination.

The content of the fluorene compound in the first and second layer-forming composition is preferably 1 to 200 parts by mass relative to 100 parts by mass of the total content of a Component C, more preferably 5 to 150 parts by mass, yet more preferably 10 to 150 parts by mass, and particularly preferably 50 to 120 parts by mass. With this embodiment, a cured material that is obtained has a higher refractive index, a lower dielectric constant, and better transparency.

### Component C: Resin

The first and second layer-forming composition preferably comprises a resin.

The resin is not particularly limited, and a known resin used as a resist may preferably be used.

With regard to the resin, one type thereof may be used on its own or two or more types may be contained.

When the first and second layer-forming composition is a positive-working photosensitive composition, the resin preferably comprises a polymer having a constituent unit containing a group formed from an acid group protected by an acid-decomposable group.

In the present invention, the ‘constituent unit containing a group formed from an acid group protected by an acid-decomposable group’ is also called ‘constituent unit c1’.

Furthermore, when the first and second layer-forming composition is a negative-working photosensitive composition, the resin preferably comprises an alkali-soluble resin.

Polymer Having Constituent Unit Containing Group that is Formed from Acid Group Protected by Acid-Decomposable Group

The first and second layer-forming composition preferably comprises a polymer having a constituent unit containing a group formed from an acid group protected by an acid-decomposable group (hereinafter, also called ‘Component C-1’).

The first and second layer-forming composition may comprise a polymer other than the polymer having a constituent unit containing a group formed from an acid group protected by an acid-decomposable group.

Component C-1 is preferably an addition-polymerization type resin, and more preferably a polymer containing a constituent unit derived from (meth)acrylic acid and/or an ester thereof (acrylic resin). It may have a constituent unit other than a constituent unit derived from (meth)acrylic acid and/or an ester thereof, for example, a styrene-derived constituent unit or a vinyl compound-derived constituent unit.

Component C-1 is a polymer having at least constituent unit c1 containing a group formed from an acid group protected by an acid-decomposable group. Due to Component C-1 comprising a polymer having constituent unit c1, a very high sensitivity photosensitive composition can be obtained.

With regard to the ‘group formed from an acid group protected by an acid-decomposable group’ in the present invention, a known acid group and acid-decomposable group may be used and are not particularly limited. Specific preferred examples of the acid group include a carboxyl group and a phenolic hydroxy group. As the acid-decomposable group, a group that is relatively easily decomposed by an acid (for example, an acetal-based functional group such as an acetal structure, a ketal structure, a tetrahydropyranyl ester group, or a tetrahydrofuranyl ester group) or a group that is relatively difficultly decomposed by an acid (for example, a tertiary alkyl group such as a tert-butyl ester group or a tertiary alkyl carbonate group such as a tert-butyl carbonate group) may be used.

The constituent unit c1 containing a group formed from an acid group protected by an acid-decomposable group is preferably a constituent unit containing a protected carboxyl group formed from a carboxyl group protected by an acid-decomposable group (also called a ‘constituent unit containing a protected carboxyl group protected by an acid-decomposable group’) or a constituent unit containing a protected phenolic hydroxy group formed from a phenolic hydroxy group protected by an acid-decomposable group (also called a ‘constituent unit containing a protected phenolic hydroxy group protected by an acid-decomposable group’).

Preferred examples of the acid-decomposable group include a 1-ethoxyethyl group, a 1-butoxyethyl group, a 1-benzyloxyethyl group, a 1-cyclohexyloxyethyl group, a tetrahydrofuranyl group, and a tetrahydropyranyl group.

It is preferable for Component C-1 to comprise a crosslinkable group, and it is more preferable for it to comprise a constituent unit containing a crosslinkable group.

The crosslinkable group is not particularly limited as long as it is a group that undergoes a curing reaction by a thermal treatment.

The crosslinkable group is preferably an epoxy group, an oxetanyl group, a group represented by —NH—CH₂—O—R (R denotes a hydrogen atom or an alkyl group having 1 to 20 carbons), or an ethylenically unsaturated group, and is more preferably an epoxy group or an oxetanyl group.

Specific examples of a monomer used in order to form a constituent unit containing an epoxy group include glycidyl acrylate, glycidyl methacrylate, glycidyl α-ethylacrylate, glycidyl α-n-propylacrylate, glycidyl α-n-butylacrylate, 3,4-epoxybutyl acrylate, 3,4-epoxybutyl methacrylate, 3,4-epoxycyclohexylmethyl acrylate, 3,4-epoxycyclohexylmethyl methacrylate, 3,4-epoxycyclohexylmethyl α-ethylacrylate, o-vinylbenzyl glycidyl ether, m-vinylbenzyl glycidyl ether, p-vinylbenzyl glycidyl ether, and alicyclic epoxy skeleton-containing compounds described in paragraphs 0031 to 0035 of Japanese registered patent No. 4168443.

Specific examples of a monomer used in order to form a constituent unit containing an oxetanyl group include oxetanyl group-containing (meth)acrylic acid esters described in paragraphs 0011 to 0016 of JP-A-2001-330953.

It is preferable for Component C-1 to comprise an acid group, and it is more preferable for it to comprise a constituent unit containing an acid group.

Examples of the acid group include a carboxylic acid group, a sulfonamide group, a phosphonic acid group, a sulfonic acid group, a phenolic hydroxy group, a sulfonamide group, a sulfonylimide group, an acid anhydride group of the above acid groups, and a group that is formed by neutralizing the above acid groups to form a salt structure; a carboxylic acid group and/or a phenolic hydroxy group are preferable. Preferred examples of the salt include, but are not particularly limited to, an alkali metal salt, an alkaline earth metal salt, and an organic ammonium salt.

The constituent unit containing an acid group is more preferably a constituent unit derived from a styrene compound, a constituent unit derived from a vinyl compound, or a constituent unit derived from (meth)acrylic acid and/or an ester thereof.

In the present invention, it is particularly preferable from the viewpoint of sensitivity for it to comprise a constituent unit containing a carboxyl group or a constituent unit containing a phenolic hydroxy group.

Specific examples of monomers used in the polymerization of Component C-1 include constituent units from styrene, tert-butoxystyrene, methylstyrene, α-methylstyrene, acetoxystyrene, methoxystyrene, ethoxystyrene, chlorostyrene, methyl vinylbenzoate, ethyl vinylbenzoate, methyl (meth)acrylate, ethyl (meth)acrylate, n-propyl (meth)acrylate, isopropyl (meth)acrylate, benzyl (meth)acrylate, isobornyl (meth)acrylate, acrylonitrile, and ethylene glycol monoacetoacetate mono(meth)acrylate. Examples other than the above include compounds described in paragraphs 0021 to 0024 of JP-A-2004-264623.

From the viewpoint of electrical characteristics, Component C-1 preferably comprises a constituent unit derived from a styrene or a monomer having an aliphatic ring skeleton, and more preferably comprises a constituent unit derived from a monomer having an aliphatic ring skeleton. Specific examples of these monomers include styrene, tert-butoxystyrene, methylstyrene, α-methylstyrene, dicyclopentanyl (meth)acrylate, cyclohexyl (meth)acrylate, isobornyl (meth)acrylate, benzyl (meth)acrylate, and dicyclopentanyl (meth)acrylate.

Furthermore, from the viewpoint of adhesion, Component C-1 is preferably a constituent unit derived from an alkyl (meth)acrylate ester. Specific examples of the alkyl (meth)acrylate ester include methyl (meth)acrylate, ethyl (meth)acrylate, propyl (meth)acrylate, and n-butyl (meth)acrylate; methyl (meth)acrylate is more preferable.

Constituent unit c1 is preferably 50 to 100 mole % relative to the total constituent units of Component C-1, more preferably 10 to 90 mole %, yet more preferably 10 to 60 mole %, and particularly preferably 20 to 50 mole %.

The constituent unit containing a crosslinkable group is preferably 5 to 90 mole % relative to the total constituent units of Component C-1, more preferably 10 to 80 mole %, and yet more preferably 10 to 60 mole %.

The constituent unit containing an acid group is preferably 1 to 80 mole % relative to the total constituent units of Component C-1, more preferably 1 to 50 mole %, yet more preferably 5 to 40 mole %, particularly preferably 5 to 30 mole %, and most preferably 5 to 20 mole %.

Constituent units other than the above are preferably no greater than 60 mole % relative to the total constituent units of Component C-1, more preferably no greater than 50 mole %, and yet more preferably no greater than 40 mole %. The lower limit value may be 0 mole %, but it is preferably for example at least 1 mole %, and more preferably at least 5 mole %.

In the present invention, when the content of a ‘constituent unit’ is defined on the basis of molar ratio, the ‘constituent unit’ has the same meaning as that of ‘monomer unit’. The ‘monomer unit’ in the present invention may be modified after polymerization using a polymer reaction, etc.

The molecular weight of Component C-1 is preferably 1,000 to 200,000 as a weight-average molecular weight on a polystyrene basis, and more preferably 2,000 to 50,000. When within this numerical range, various properties are good. The ratio of number-average molecular weight Mn and weight-average molecular weight Mw (dispersity, Mw/Mn) is preferably 1.0 to 5.0, and more preferably 1.5 to 3.5.

Furthermore, as Component C-1, resins described in paragraphs 0016 to 0080 of JP-A-2014-132292 may suitably be used.

The content of Component C-1 in the positive-working photosensitive composition is preferably 20 to 99.9 mass % relative to the total solids content of the photosensitive composition, more preferably 50 to 98 mass %, and yet more preferably 70 to 95 mass %. When the content is in this range, pattern forming properties when developed are good, and a cured material having a higher refractive index is obtained.

### Alkali-Soluble Resin

From the viewpoint of resolution and film properties improvement, the first and second layer-forming composition preferably comprises an alkali-soluble resin (hereinafter, also called ‘Component C-2’).

Component C-2 is not particularly limited, and a known alkali-soluble resin may be used.

A polar group that imparts alkali solubility to the alkali-soluble resin is not particularly limited, and it may comprise a known polar group; preferred examples include a carboxyl group, a hydroxy group, a phosphoric acid group, and a sulfonic acid group, and a carboxyl group is particularly preferable.

The binder polymer is preferably a linear organic polymer. As such a linear organic polymer, any known polymer may be used, but an acrylic resin is preferable. The linear organic polymer may not only be used as a film-forming agent but may also be selected according to the intended application with an aqueous, weakly alkaline aqueous, or organic solvent developer. For example, when a water-soluble organic polymer is used, development with water becomes possible. Examples of such a linear organic polymer include a radical polymer containing a carboxylic acid group in a side chain such as those described in JP-A-59-44615, JP-B-54-34327 (JP-B denotes a Japanese examined patent application publication), JP-B-58-12577, JP-B-54-25957, JP-A-54-92723, JP-A-59-53836, and JP-A-59-71048, that is, a resin formed by homopolymerization or copolymerization of a carboxyl group-containing monomer, a resin formed by hydrolysis, half-esterification, or half-amidation of an acid anhydride unit of a homopolymer or copolymer of an acid anhydride-containing monomer, and an epoxyacrylate formed by modifying an epoxy resin with an unsaturated monocarboxylic acid or acid anhydride.

Examples of the carboxyl group-containing monomer include acrylic acid, methacrylic acid, itaconic acid, crotonic acid, maleic acid, fumaric acid, and 4-carboxylstyrene.

Examples of the acid anhydride-containing monomer include maleic anhydride.

Similarly, examples include an acidic cellulose derivative containing a carboxylic acid group in a side chain. Other than the above, one formed by adding a cyclic acid anhydride to a hydroxy group-containing polymer is also useful.

The weight-average molecular weight of the alkali-soluble resin is preferably at least 5,000, and more preferably at least 10,000 but no greater than 300,000, and the number-average molecular weight is preferably at least 1,000, and more preferably at least 2,000 but no greater than 250,000. The polydispersity (weight-average molecular weight/number-average molecular weight) is preferably at least 1, and more preferably at least 1.1 but no greater than 10.

The resin that can be used in the present invention may be any of a random polymer, a block polymer, a graft polymer, etc.

The content of Component C-2 in the negative-working photosensitive composition is preferably 1 to 40 mass % relative to the total solids content of the negative-working photosensitive composition, more preferably 3 to 30 mass %, and yet more preferably 4 to 20 mass %.

### Component D: Photo-Acid Generator

The first and second layer-forming composition preferably comprises a photo-acid generator as Component D; in particular when the first and second layer-forming composition is a positive-working photosensitive composition, it particularly preferably comprises a photo-acid generator.

The ‘light’ is not particularly limited as long as it is actinic radiation that can apply energy that can generate an initiating species from the photo-acid generator and/or a photopolymerization initiator, which is described later, upon irradiation therewith, and widely includes α-rays, γ-rays, X rays, ultraviolet (UV), visible light, and an electron beam. Among them, light containing at least UV is preferable.

Furthermore, when the first and second layer-forming composition is a positive-working photosensitive composition, it is preferably a chemically amplified type positive-working photosensitive composition (chemically amplified positive-working photosensitive composition) and may be a non-chemically amplified type positive-working photosensitive composition that employs a 1,2-quinone diazide compound as a photo-acid generator sensitive to actinic radiation. In terms of high sensitivity and excellent transparency, it is preferably a chemically amplified positive-working photosensitive composition.

The photo-acid generator used in the present invention is preferably a compound that is sensitive to actinic radiation having a wavelength of at least 300 nm, and preferably a wavelength of 300 to 450 nm, and that generates an acid, but its chemical structure is not limited. Furthermore, with regard to a photo-acid generator that is not directly sensitive to actinic radiation having a wavelength of at least 300 nm, a compound that becomes sensitive to actinic radiation having a wavelength of at least 300 nm when used in combination with a sensitizer and that generates an acid may be used preferably in combination with a sensitizer. As the photo-acid generator used in the present invention, a photo-acid generator that has a pKa of no greater than 4 and that can generate an acid is preferable, a photo-acid generator that has a pKa of no greater than 3 and that can generate an acid is more preferable, and a photo-acid generator that has a pKa of no greater than 2 and that can generate an acid is most preferable.

Examples of the photo-acid generator include a trichloromethyl-s-triazine, a sulfonium salt, an iodonium salt, a quaternary ammonium salt, a diazomethane compound, an imidosulfonate compound, and an oxime sulfonate compound. Among them, from the viewpoint of insulating properties and sensitivity, it is preferable to use an oxime sulfonate compound. With regard to these photo-acid generators, one type may be used on its own or two or more types may be used in combination. Specific examples of a trichloromethyl-s-triazine, a diaryliodonium salt, a triarylsulfonium salt, a quaternary ammonium salt, and a diazomethane derivative include compounds described in paragraphs 0083 to 0088 of JP-A-2011-221494.

Preferred examples of an oxime sulfonate compound, that is, a compound having an oxime sulfonate structure, include a compound containing an oxime sulfonate structure represented by Formula D1 below.

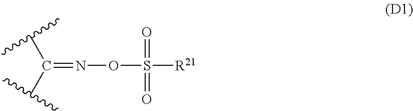

In Formula D1, R²¹ denotes an alkyl group or an aryl group, and the wavy line portion denotes the position via which it is bonded to another group.

All groups may be substituted, and the alkyl group denoted by R²¹ may be straight-chain, branched, or cyclic. Allowed substituents are explained below.

The alkyl group of R²¹ is preferably a straight-chain or branched alkyl group having 1 to 10 carbons. The alkyl group of R²¹ may be substituted with an aryl group having 6 to 11 carbons, an alkoxy group having 1 to 10 carbons, or a cycloalkyl group (preferably a bicycloalkyl group, etc. including a bridged alicyclic group such as a 7,7-dimethyl-2-oxonorbornyl group).

The aryl group denoted by R²¹ is preferably an aryl group having 6 to 11 carbons, and more preferably a phenyl group or a naphthyl group. The aryl group of R²¹ may be substituted with an alkyl group having 1 to 10 carbons, an alkoxy group having 1 to 10 carbons, or a halogen atom.

Examples of the oxime sulfonate compound include compounds described in paragraphs 0114 to 0120 of JP-A-2011-221494 and paragraphs 0116 to 0145 of JP-A-2014-132292, but the present invention is not limited thereto.

In the first and second layer-forming composition, the photo-acid generator is preferably used at 0.1 to 30 parts by mass relative to 100 parts by mass of the resin in the first and second layer-forming composition, more preferably 0.1 to 10 parts by mass, and particularly preferably 0.5 to 10 parts by mass.

Furthermore, with regard to the photo-acid generator, one type may be used on its own or two or more types may be used in combination.

### Component E: Ethylenically Unsaturated Compound

The first and second layer-forming composition preferably comprises an ethylenically unsaturated compound as Component E; when the first and second layer-forming composition is a negative-working photosensitive composition in particular, it is more preferable for it to comprise an ethylenically unsaturated compound, and it is yet more preferable for it to comprise a tri- or higher-functional ethylenically unsaturated compound.

The ethylenically unsaturated compound in the present invention is an addition-polymerizable compound having at least one ethylenically unsaturated double bond, and is preferably selected from compounds having at least one, and preferably two, terminal ethylenically unsaturated bonds. Such compounds are widely known in the present technical field, and in the present invention they can be used without particular limitations.

They have a chemical configuration such as for example a monomer, a prepolymer, that is, a dimer, a trimer, or an oligomer, or a mixture thereof, or a copolymer thereof. Examples of the monomer and the copolymer thereof include an unsaturated carboxylic acid (for example, acrylic acid, methacrylic acid, itaconic acid, crotonic acid, isocrotonic acid, maleic acid, etc.), an ester thereof, and an amide thereof, and it is preferable to use an ester of an unsaturated carboxylic acid with an aliphatic polyhydric alcohol compound or an amide of an unsaturated carboxylic acid with an aliphatic polyamine compound. Furthermore, an addition reaction product of an unsaturated carboxylic acid ester or unsaturated carboxylamide having a nucleophilic substituent such as a hydroxy group, an amino group, or a mercapto group with a monofunctional or polyfunctional isocyanate or epoxy, or a dehydration-condensation reaction product with a monofunctional or polyfunctional carboxylic acid is also suitably used. Furthermore, an addition reaction product of an unsaturated carboxylic acid ester or unsaturated carboxylamide having an electrophilic substituent such as an isocyanate group or an epoxy group with a monofunctional or polyfunctional alcohol, amine, or thiol; and a substitution reaction product of an unsaturated carboxylic acid ester or unsaturated carboxylamide having a leaving substituent such as a halogen group or a tosyloxy group with a monofunctional or polyfunctional alcohol, amine, or thiol are also suitable. Moreover, as another example, instead of the above unsaturated carboxylic acid, a group of compounds in which it is replaced by an unsaturated phosphonic acid, a styrene, a vinyl ether, etc. may also be used.

Specific examples of the ester monomer of an aliphatic polyhydric alcohol compound with an unsaturated carboxylic acid include an acrylic acid ester such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tris(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tris(acryloyloxyethyl) isocyanurate, a polyester acrylate oligomer, or an isocyanuric acid ethylene oxide (EO)-modified triacrylate.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis-[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

Examples of isocrotonic acid esters include ethylene glycol diisocrotonate, pentaerythritol diisocrotonate, and sorbitol tetraisocrotonate.

Examples of maleic acid esters include ethylene glycol dimalate, triethylene glycol dimalate, pentaerythritol dimalate, and sorbitol tetramalate.

Examples of other esters that can suitably be used include aliphatic alcohol esters described in JP-B-51-47334 and JP-A-57-196231, those having an aromatic skeleton described in JP-A-59-5240, JP-A-59-5241, and JP-A-2-226149, and those having an amino group described in JP-A-1-165613. Furthermore, the above ester monomers may also be used as mixtures.

Furthermore, specific examples of the amide monomer of an aliphatic polyamine compound with an unsaturated carboxylic acid include methylene bisacrylamide, methylene bismethacrylamide, 1,6-hexamethylene bisacrylamide, 1,6-hexamethylene bismethacrylamide, diethylenetriamine trisacrylamide, xylylene bisacrylamide, and xylylene bismethacrylamide.

Preferred examples of other amide monomers include those having a cyclohexylene structure described in JP-B-54-21726.

Moreover, urethane acrylates described in JP-A-51-37193, JP-B-2-32293, and JP-B-2-16765 and urethane compounds having an ethylene oxide skeleton described in JP-B-58-49860, JP-B-56-17654, JP-B-62-39417, and JP-B-62-39418 are also suitable. Furthermore, due to the use of a polymerizable compound having an amino structure or a sulfide structure in the molecule described in JP-A-63-277653, JP-A-63-260909, and JP-A-1-105238, a photosensitive composition having very good development speed can be obtained.

Other examples include polyfunctional acrylates and methacrylates such as epoxyacrylates obtained by a reaction between (meth)acrylic acid and an epoxy resin and polyester acrylates described in each of JP-A-48-64183, JP-B-49-43191, and JP-B-52-30490. Furthermore, examples also include specific unsaturated compounds described in JP-B-46-43946, JP-B-1-40337, and JP-B-1-40336 and vinyl phosphonic acid-based compounds described in JP-A-2-25493. In some cases, a structure containing a perfluoroalkyl group described in JP-A-61-22048 is suitably used. Furthermore, photocurable monomers and oligomers described in the Journal of the Adhesion Society of Japan Vol. 20, No. 7, pp. 300 to 308 (1984) may also be used.

With regard to these ethylenically unsaturated compounds, the structure thereof and details of the method in terms of their use alone or in combination, the amount added, etc. may be set freely according to the final performance design of the photosensitive composition. For example, they are selected from the following viewpoints.

In terms of sensitivity, the larger the content of unsaturated groups per molecule in the structure, the more preferable it is, and in many cases a di- or higher-functional structure is preferable. In order to enhance the strength of a cured film, a tri- or higher-functional structure is preferable, and a method in which both sensitivity and strength are adjusted by the combined use of ones having different functionality and/or different polymerizable groups (for example, an acrylic acid ester, a methacrylic acid ester, a styrene compound, or a vinyl ether compound) is also effective.

Furthermore, selection of the ethylenically unsaturated compound and the method of use are important factors for compatibility and dispersibility with respect to other components (for example, a photopolymerization initiator, inorganic particles, etc.) and, for example, compatibility can be improved by the use of a low purity compound or by the combined use of two or more types of other components. Moreover, for the purpose of improving adhesion to a hard surface such as a substrate, a specific structure can be selected.

The content of the ethylenically unsaturated compound is preferably 5 to 90 mass % relative to the total solids content of the first and second layer-forming composition, more preferably 10 to 85 mass %, and yet more preferably 20 to 80 mass %. When in this range, adhesion and developability are both good without the refractive index being degraded.

### Component F: Photopolymerization Initiator

The first and second layer-forming composition preferably comprises as Component F a photopolymerization initiator, and when the first and second layer-forming composition is a negative-working photosensitive composition in particular, it particularly preferably comprises a photopolymerization initiator.

The photopolymerization initiator also includes Component D, but the photopolymerization initiator is preferably a radical photopolymerization initiator.

The photopolymerization initiator used in the present invention is preferably a compound that is decomposed by light and initiates and promotes polymerization of a polymerizable compound such as an ethylenically unsaturated compound and that has absorption in a wavelength region of at least 300 nm but no greater than 500 nm. With regard to the photopolymerization initiator, one type may be used on its own or two more types may be used in combination.

Examples of the photopolymerization initiator include an oxime ester compound, an organic halide compound, an oxydiazole compound, a carbonyl compound, a ketal compound, a benzoin compound, an acridine compound, an organic peroxide compound, an azo compound, a coumarin compound, an azide compound, a metallocene compound, a hexaarylbiimidazole compound, an organoboric acid compound, a disulfonic acid compound, an onium salt compound, and an acylphosphine (oxide) compound. Among them, from the viewpoint of sensitivity, an oxime ester compound and a hexaarylbiimidazole compound are preferable, and an oxime ester compound is more preferable.

As the oxime ester compound, compounds described in JPA-2000-80068, JP-A-2001-233842, published Japanese translation 2004-534797 of a PCT application, JP-A-2007-231000, JP-A-2009-134289, and paragraphs 0046 to 0059 of International Laid-open Patent 2012/057165 may be used.

Specific examples of the organic halide compound include compounds described in Wakabayashi et al., ‘Bull Chem. Soc. Japan’, 42, 2924 (1969), U.S. Pat. No. 3,905,815, JP-B-46-4605, JP-A-48-36281, JP-A-55-32070, JP-A-60-239736, JP-A-61-169835, JP-A-61-169837, JP-A-62-58241, JP-A-62-212401, JP-A-63-70243, JP-A-63-298339, M. P. Hutt, et al., Journal of Heterocyclic Chemistry, Vol. 7, Issue 3, 511-518 (1970), etc.; an oxazole compound substituted with a trihalomethyl group and an s-triazine compound may in particular be cited.

Examples of the hexaaryl biimidazole compound include various compounds described in JP-B-6-29285, U.S. Pat. Nos. 3,479,185, 4,311,783, 4,622,286, etc.

Examples of the acylphosphine (oxide) compound include a monoacylphosphine oxide compound and a bisacylphosphine oxide compound, and specific examples include Irgacure 819, Darocur 4265, and Darocur TPO from BASF.

With regard to the photopolymerization initiator, one type may be used or two or more types may be used in combination.

The content of the photopolymerization initiator in the first and second layer-forming composition is preferably 0.5 to 30 parts by mass relative to 100 parts by mass of the total solids content of the composition, more preferably 1 to 20 parts by mass, yet more preferably 1 to 10 parts by mass, and particularly preferably 1.5 to 5 parts by mass.

### Component G: Solvent

The first and second layer-forming composition may comprise as Component G a solvent. The first and second layer-forming composition is preferably prepared as a liquid in which the above components and an optional component, which is further described later, are dissolved and/or dispersed in a solvent.

As the solvent used in the first and second layer-forming composition, a known solvent may be used, and examples include an ethylene glycol monoalkyl ether, an ethylene glycol dialkyl ether, an ethylene glycol monoalkyl ether acetate, a propylene glycol monoalkyl ether, a propylene glycol dialkyl ether, a propylene glycol monoalkyl ether acetate, a diethylene glycol dialkyl ether, a diethylene glycol monoalkyl ether acetate, a dipropylene glycol monoalkyl ether, a dipropylene glycol dialkyl ether, a dipropylene glycol monoalkyl ether acetate, an ester, a ketone, an amide, and a lactone. Solvents described in paragraphs 0174 to 0178 of JP-A-2011-221494 may also be cited as examples.
In addition to these solvents, as necessary, a solvent such as benzyl ethyl ether, dihexyl ether, ethylene glycol monophenyl ether acetate, diethylene glycol monomethyl ether, diethylene glycol monoethyl ether, isophorone, caproic acid, caprylic acid, 1-octanol, 1-nonanol, benzyl alcohol, anisole, benzyl acetate, ethyl benzoate, diethyl oxalate, diethyl maleate, ethylene carbonate, or propylene carbonate may be added.
With regard to these solvents, one type may be used on its own or two or more types may be used in combination. With regard to solvents that can be used in the present invention, it is preferable to use one type on its own or two types in combination.

It is also preferable for Component G to be a solvent having a boiling point of at least 130° C. but less than 160° C., a solvent having a boiling point of at least 160° C., or a mixture thereof.

Examples of solvents having a boiling point of at least 130° C. but less than 160° C. include propylene glycol monomethyl ether acetate (boiling point 146° C.), propylene glycol monoethyl ether acetate (boiling point 158° C.), propylene glycol methyl n-butyl ether (boiling point 155° C.), and propylene glycol methyl n-propyl ether (boiling point 131° C.).

Examples of solvents having a boiling point of at least 160° C. include ethyl 3-ethoxypropionate (boiling point 170° C.), diethylene glycol methyl ethyl ether (boiling point 176° C.), propylene glycol monomethyl ether propionate (boiling point 160° C.), dipropylene glycol methyl ether acetate (boiling point 213° C.), 3-methoxybutyl ether acetate (boiling point 171° C.), diethylene glycol diethyel ether (boiling point 189° C.), diethylene glycol dimethyl ether (boiling point 162° C.), propylene glycol diacetate (boiling point 190° C.), diethylene glycol monoethyl ether acetate (boiling point 220° C.), dipropylene glycol dimethyl ether (boiling point 175° C.), and 1,3-butylene glycol diacetate (boiling point 232° C.).

Among them, the solvent is preferably a propylene glycol monoalkyl ether acetate, and particularly preferably propylene glycol monomethyl ether acetate.

The content of the solvent in the first and second layer-forming composition is preferably at least 20 mass % but no greater than 95 mass %, more preferably at least 50 mass % but no greater than 95 mass %, and yet more preferably at least 65 mass % but no greater than 95 mass %. When the content of the solvent is in this range, the coating properties and the flatness during coating are good.

### Component H: Alkoxysilane Compound

The first and second layer-forming composition preferably comprises as Component H an alkoxysilane compound. When an alkoxysilane compound is used, adhesion between a film formed from the first and second layer-forming composition and a support, etc. can be improved.

The alkoxysilane compound is not particularly limited as long as it is a compound having at least one alkoxy group directly bonded to a silicon atom, but is preferably a dialkoxysilyl group- and/or trialkoxysilyl group-containing compound, and more preferably a trialkoxysilyl group-containing compound.

The alkoxysilane compound that can be used in the present invention is preferably a compound that improves adhesion between a cured film and a substrate such as a silicon compound such as silicon, silicon oxide, or silicon nitride, or a metal such as gold, copper, molybdenum, titanium, or aluminum. Specifically, a known silane coupling agent, etc. is also effective. A silane coupling agent having an ethylenically unsaturated bond is preferable.

Examples of the silane coupling agent include γ-aminopropyltrimethoxysilane, γ-aminopropyltriethoxysilane, a γ-glycidoxypropyltrialkoxysilane, a γ-glycidoxypropyldialkoxysilane, a γ-methacryloxypropyltrialkoxysilane, a γ-methacryloxypropyldialkoxysilane, a γ-chloropropyltrialkoxysilane, a γ-mercaptopropyltrialkoxysilane, a β-(3,4-epoxycyclohexyl)ethyltrialkoxysilane, and a vinyltrialkoxysilane. Among them, a γ-methacryloxypropyltrialkoxysilane, a γ-acryloxypropyltrialkoxysilane, a vinyltrialkoxysilane, and a γ-glycidoxypropyltriacoxysilane are more preferable. With regard to these, one type may be used on its own or two or more types may be used in combination.

Examples of commercial products include KBM-403 and KBM-5103 manufactured by Shin-Etsu Chemical Co., Ltd.

The content of the alkoxysilane compound in the first and second layer-forming composition is preferably 0.1 to 30 mass % relative to the total solids content of the composition, more preferably 2 to 20 mass %, and yet more preferably 3 to 10 mass %. With regard to the alkoxysilane compound, one type may be used on its own or two or more types may be used in combination. When two or more types are used, the total amount is preferably in the above range.

### Component I: Basic Compound

The first and second layer-forming composition, in particular the positive-working photosensitive composition, preferably comprises a basic compound from the viewpoint of liquid storage stability.

Any basic compound may be selected from those used in a chemically amplified resist and used. Examples include an aliphatic amine, an aromatic amine, a heterocyclic amine, a quaternary ammonium hydroxide, and a quaternary ammonium salt of a carboxylic acid.

Examples of the aliphatic amine include trimethylamine, diethylamine, triethylamine, di-n-propylamine, tri-n-propylamine, di-n-pentylamine, tri-n-pentylamine, diethanolamine, triethanolamine, dicyclohexylamine, and dicyclohexylmethylamine.

Examples of the aromatic amine include aniline, benzylamine, N,N-dimethylaniline, and diphenylamine.

Examples of the heterocyclic amine include pyridine, 2-methylpyridine, 4-methylpyridine, 2-ethylpyridine, 4-ethylpyridine, 2-phenylpyridine, 4-phenylpyridine, N-methyl-4-phenylpyridine, 4-dimethylaminopyridine, imidazole, benzimidazole, 4-methylimidazole, 2-phenylbenzimidazole, 2,4,5-triphenylimidazole, nicotine, nicotinic acid, nicotinamide, quinoline, 8-oxyquinoline, pyrazine, pyrazole, pyridazine, purine, pyrrolidine, piperidine, piperazine, morpholine, 4-methylmorpholine, N-cyclohexyl-N′-[2-(4-morpholinyl)ethyl]thiourea, 1,5-diazabicyclo[4.3.0]-5-nonene, and 1,8-diazabicyclo[5.3.0]-7-undecene.

Examples of the quaternary ammonium hydroxide include tetramethylammonium hydroxide, tetraethylammonium hydroxide, tetra-n-butylammonium hydroxide, and tetra-n-hexylammonium hydroxide.

Examples of the quaternary ammonium salt of a carboxylic acid include tetramethylammonium acetate, tetramethylammonium benzoate, tetra-n-butylammonium acetate, and tetra-n-butylammonium benzoate.

With regard to the basic compound that can be used in the present invention, one type thereof may be used on its own or two or more types may be used in combination, but it is preferable to use two or more types in combination, it is more preferable to use two types in combination, and it is yet more preferable to use two types of heterocyclic amines in combination.

The content of the basic compound in the first and second layer-forming composition is preferably 0.001 to 1 wt % relative to the total organic solids content of the composition, and more preferably 0.002 to 0.5 wt %.

### Component J: Surfactant

The first and second layer-forming composition of the present invention may comprise a surfactant.

As the surfactant, any of anionic, cationic, nonionic, or amphoteric surfactants may be used, but a nonionic surfactant is preferable. The surfactant is preferably a nonionic surfactant, and more preferably a fluorine-based surfactant.

Examples of the surfactant that can be used in the present invention include commercial products such as Megafac F142D, F172, F173, F176, F177, F183, F479, F482, F554, F780, F781, F781-F, R30, R08, F-472SF, BL20, R-61, and R-90 (DIC), Fluorad FC-135, FC-170C, FC-430, and FC-431, and Novec FC-4430 (Sumitomo 3M Limited), AsahiGuard AG7105, 7000, 950, and 7600, and Surflon S-112, S-113, S-131, S-141, S-145, S-382, SC-101, SC-102, SC-103, SC-104, SC-105, and SC-106 (Asahi Glass), Eftop EF351, 352, 801, and 802 (Mitsubishi Materials Electronic Chemicals Co., Ltd.), and Ftergent 250 (Neos Company Limited). Examples other than the above include the KP (Shin-Etsu Chemical Co., Ltd.), Polyflow (Kyoeisha Chemical Co., Ltd.), Eftop (Mitsubishi Materials Electronic Chemicals Co., Ltd.), Megafac (DIC), Fluorad (Sumitomo 3M Limited), AsahiGuard and Surflon (Asahi Glass), and PolyFox (OMNOVA) series.

Preferred examples of the surfactant also include compounds described in paragraphs 0119 to 0123 of JP-A-2014-238438.

When added, the content of the surfactant in the first and second layer-forming composition is preferably 0.001 to 5.0 mass % relative to the total solids content of the composition, and more preferably 0.01 to 2.0 mass %.

With regard to the surfactant, only one type may be contained or two or more types may be contained. When two or more types are contained, the total amount is preferably in the above range.

### Component K: Thermal Crosslinking Agent

The first and second layer-forming composition preferably comprises a thermal crosslinking agent as necessary. Due to a thermal crosslinking agent being added, a cured film obtained using the first and second layer-forming composition can be made stronger.

The thermal crosslinking agent is not limited as long as it can cause a crosslinking reaction upon heating (however, Component A to Component C and Component E are excluded). Examples include a compound containing at least two epoxy groups or oxetanyl groups per molecule described in paragraphs 0188 to 0191 of JP-A-2011-221494, an alkoxymethyl group-containing crosslinking agent described in paragraphs 0192 to 0194 of JP-A-2011-221494, a compound having at least one ethylenically unsaturated double bond, or a blocked isocyanate compound described in paragraphs 0147 to 0149 of JP-A-2012-208200.

The amount of thermal crosslinking agent added in the first and second layer-forming composition is preferably 0.01 to 50 parts by mass relative to 100 parts by mass of the total solids content of the composition, more preferably 0.1 to 30 parts by mass, and yet more preferably 0.5 to 20 parts by mass. Due to it being added in this range, a cured film having excellent mechanical strength and solvent resistance is obtained. With regard to the thermal crosslinking agent, a plurality thereof may be used in combination, and in this case the content is calculated by adding the contents of all the thermal crosslinking agents.

### Component L: Heterocyclic Compound Having Two or More Nitrogen Atoms

When a3 is used as Component A, the first and second layer-forming composition preferably comprises as Component L a heterocyclic compound having two or more nitrogen atoms from the viewpoint of reduction in haze.

Component L is not particularly limited as long as it has two or more nitrogen atoms, but it is preferable for it to be a heterocyclic compound having two or more nitrogen atoms as members of a heterocyclic ring, more preferably a compound having a heterocyclic structure having nitrogen atoms at 1- and 3-positions, and yet more preferably a compound having a 5-membered or 6-membered heterocyclic structure having nitrogen atoms at 1- and 3-positions.

With regard to Component L, one type thereof may be used on its own or two or more types may be used in combination.

The content of Component L in the first and second layer-forming composition is preferably 0.1 to 20 mass % relative to the total solids content of the composition, more preferably 0.5 to 15 mass %, and yet more preferably 0.5 to 10 mass %. When in this range, a cured material having better dispersibility for inorganic particles and lower haze can be obtained.

### Antioxidant

The first and second layer-forming composition preferably comprises an antioxidant.

As the antioxidant, a known antioxidant may be contained. Due to an antioxidant being added, there are the advantages that coloration of a cured film can be prevented, reduction in film thickness due to decomposition can be suppressed, and the heat-resistant transparency is excellent.

Examples of such an antioxidant include a phosphorus-based antioxidant, an amide, a hydrazide, a hindered amine-based antioxidant, a sulfur-based antioxidant, a phenol-based antioxidant, an ascorbic acid, zinc sulfate, a saccharide, a nitrite, a sulfite salt, a thiosulfate, and a hydroxylamine derivative. Among them, from the viewpoint of coloration of a cured film and reduction in film thickness, a phenolic antioxidant, an amide-based antioxidant, a hydrazide-based antioxidant, and a sulfur-based antioxidant are particularly preferable. With regard to these, one type may be used on its own or two or more types may be mixed.

Examples of commercially available phenolic antioxidants include ADK STAB AO-15, ADK STAB AO-18, ADK STAB AO-20, ADK STAB AO-23, ADK STAB AO-30, ADK STAB AO-37, ADK STAB AO-40, ADK STAB AO-50, ADK STAB AO-51, ADK STAB AO-60, ADK STAB AO-70, ADK STAB AO-80, ADK STAB AO-330, ADK STAB AO-412S, ADK STAB AO-503, ADK STAB A-611, ADK STAB A-612, ADK STAB A-613, ADK STAB PEP-4C, ADK STAB PEP-8, ADK STAB PEP-8W, ADK STAB PEP-24G, ADK STAB PEP-36, ADK STAB PEP-36Z, ADK STAB HP-10, ADK STAB 2112, ADK STAB 260, ADK STAB 522A, ADK STAB 1178, ADK STAB 1500, ADK STAB C, ADK STAB 135A, ADK STAB 3010, ADK STAB TPP, ADK STAB CDA-1, ADK STAB CDA-6, ADK STAB ZS-27, ADK STAB ZS-90, and ADK STAB ZS-91 (all from ADEKA), and Irganox 245FF, Irganox 1010FF, Irganox 1010, Irganox MD1024, Irganox 1035FF, Irganox 1035, Irganox 1098, Irganox 1330, Irganox 1520L, Irganox 3114, Irganox 1726, Irgafos 168, Irgamod 295, and Tinuvin 405 (all from BASF). Among them, ADK STAB AO-60, ADK STAB AO-80, Irganox 1726, Irganox 1035, Irganox 1098, and Tinuvin 405 may suitably be used.

The content of the antioxidant is preferably 0.1 to 10 mass % relative to the total solids content of the composition, more preferably 0.2 to 5 mass %, and particularly preferably 0.5 to 4 mass %. With this range, a film that is formed has sufficient transparency and good sensitivity when forming a pattern.

Furthermore, as an additive other than an antioxidant, various types of UV absorber or metal deactivating agent, etc. described in “Kobunshi Tenkazai no Shintenkai (New Developments in Polymer Additives)” (The Nikkan Kogyo Shimbun, Ltd.) may be added to the first and second layer-forming composition.

### Dispersant

The first and second layer-forming composition preferably comprises a dispersant. Due to it comprising a dispersant, the dispersibility of Component A, in particular a3, in the composition can be improved.

A known dispersant may be used as the dispersant; for example, a known pigment dispersing agent may be appropriately selected and used.

As the dispersant, for example, a known pigment dispersing agent may be appropriately selected and used.

Furthermore, as the dispersant, a polymeric dispersant may preferably be used. The polymeric dispersant referred to here is a dispersant having a molecular weight (weight-average molecular weight) of at least 1,000.

Many types of compounds may be used as the dispersant. Specific examples include cationic surfactants such as the organosiloxane polymer KP341 (Shin-Etsu Chemical Co., Ltd.), the (meth)acrylic acid-based (co)polymers Polyflow No. 75, No. 90, and No. 95 (Kyoeisha Chemical Co., Ltd.), and W001 (Yusho Co., Ltd.); nonionic surfactants such as polyoxyethylene lauryl ether, polyoxyethylene stearyl ether, polyoxyethylene oleyl ether, polyoxyethylene octylphenyl ether, polyoxyethylene nonylphenyl ether, polyethylene glycol dilaurate, polyethylene glycol distearate, and sorbitan fatty acid ester; anionic surfactants such as W004, W005, and W017 (Yusho Co., Ltd.); polymeric dispersants such as EFKA-46, EFKA-47, EFKA-47EA, EFKA polymer 100, EFKA polymer 400, EFKA polymer 401, and EFKA polymer 450 (all from Ciba Specialty Chemicals), Disperse Aid 6, Disperse Aid 8, Disperse Aid 15, and Disperse Aid 9100 (all from San Nopco Limited); various types of Solsperse dispersants such as Solsperse 3000, 5000, 9000, 12000, 13240, 13940, 17000, 24000, 26000, and 28000 (AstraZeneca); Adeka Pluronic L31, F38, L42, L44, L61, L64, F68, L72, P95, F77, P84, F87, P94, L101, P103, F108, L121, and P-123 (ADEKA), and Isonet S-20 (Sanyo Chemical Industries, Ltd.), DISPERBYK 101, 103, 106, 108, 109, 111, 112, 116, 130, 140, 142, 162, 163, 164, 166, 167, 170, 171, 174, 176, 180, 182, 2000, 2001, 2050, and 2150 (BYK-Chemie GmbH). Other than the above, there can be cited an oligomer or polymer containing a polar group at a molecular terminal or in a side chain, such as an acrylic copolymer.

With regard to the dispersant, one type thereof may be used on its own or two or more types may be used in combination.

The content of the dispersant in the first and second layer-forming composition is preferably in the range of 5 to 70 mass % relative to the total solids content of the composition, and more preferably in the range of 10 to 50 mass %.

### Polymerization Inhibitor

The first and second layer-forming composition may comprise a polymerization inhibitor. Due to it comprising a polymerization inhibitor, a polymerization reaction due to the leakage of light is suppressed, and the developability is excellent.

The polymerization inhibitor referred to here is a substance that carries out hydrogen supply (or the imparting of hydrogen), energy supply (or the imparting of energy), electron supply (or the imparting of an electron), etc. to a polymerization-initiating radical component generated from a polymerization initiator upon exposure or heat to thus deactivate a polymerization-initiating radical and inhibit initiation of polymerization. For example, compounds described in paragraphs 0154 to 0173 of JP-A-2007-334322, etc. may be used.

The content of the polymerization inhibitor in the first and second layer-forming composition is not particularly limited but is preferably 0.005 to 0.5 mass % relative to the total solids content of the composition, and more preferably 0.01 to 0.5 mass %. Adjusting the amount of polymerization inhibitor added enables the patterning properties to be improved without impairing the sensitivity.

### Migration Inhibitor

The first and second layer-forming composition may comprise a migration inhibitor. Due to it comprising a migration inhibitor, it is possible to improve the reliability under high temperature and high humidity of an electronic component produced using the layered body for a transparent conductive member of the present invention.

Examples of such a migration inhibitor include a phenol compound, a phosphine compound, an imidazole compound, a thiazole compound, a triazole compound, a tetrazole compound, a pyridine compound, a pyrimidine compound, a triazine compound, a thiol compound, and a sulfide compound. Among them, a phosphine compound, an imidazole compound, a thiazole compound, a triazole compound, a triazine compound, a thiol compound, and a sulfide compound are preferable. With regard to these, one type may be used on its own or two or more types may be mixed.

Specific examples of the migration inhibitor include the compounds shown below.

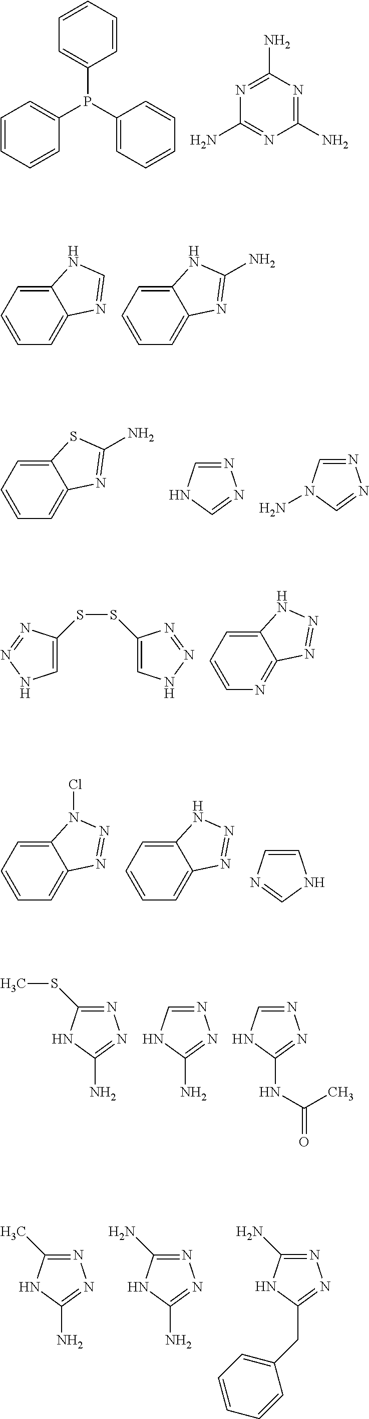

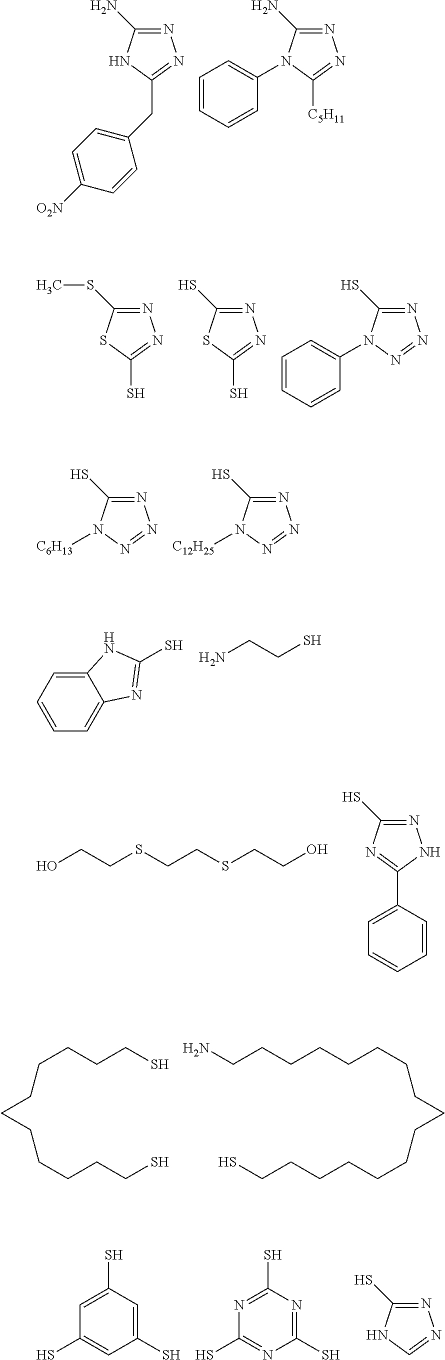

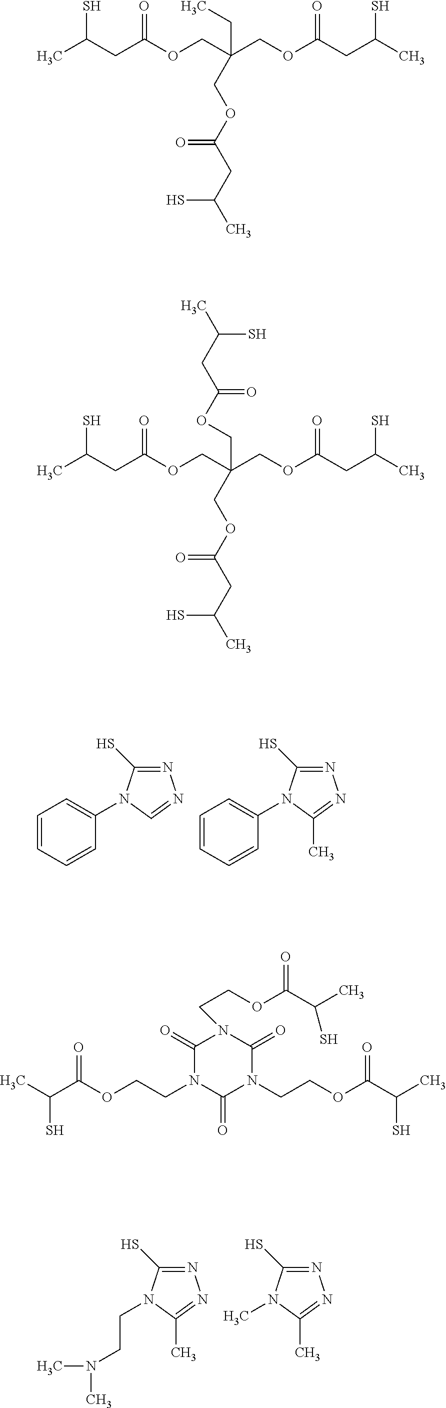

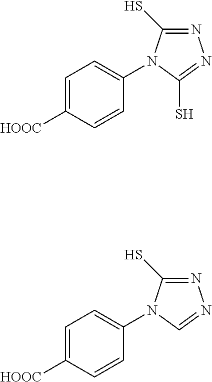 [SMILES: O=C(O)c1ccc(-n2c(S)nnc2S)cc1 ; O=C(O)c1ccc(-n2cnnc2S)cc1]

Other than the above compounds, compounds described in JP-A-2014-129441 and JP-A-2014-141592 can also be cited.

The content of the migration inhibitor is preferably 0.1 to 20 mass % relative to the total solids content of the composition, more preferably 0.2 to 10 mass %, and particularly preferably 0.5 to 7 mass %. When in this range, the hardness of a film formed is sufficient, and the migration resistance is also good.

### Other Components

In addition to the above components, the first and second layer-forming composition may comprise as necessary another component such as a sensitizer, an adhesion-improving agent, an acid-increasing agent, a development accelerator, a plasticizer, a thickener, or an organic or inorganic precipitation inhibitor. As these components, those described in for example JP-A-2014-235216, JP-A-2009-98616, JP-A-2009-244801, and JP-A-2011-221494 and other known components may be used.

Furthermore, as another additive, a thermal radical generator described in paragraphs 0120 to 0121 of JP-A-2012-8223 and a nitrogen-containing compound and a thermal acid generator described in International Patent Laid-open No. 2011/136074 may be used.

### Transparent Conductive Member

The transparent conductive member of the present invention is formed using the layered body for a transparent conductive member of the present invention. That is, it comprises a cured material formed by curing the layered body for a transparent conductive member of the present invention.

The transparent conductive member of the present invention may suitably be used as a touch sensor for a touch panel or as a wiring material in a liquid crystal display and an organic EL display device. As a touch sensor for a touch panel, it is suitably used as a film type touch sensor and a touch sensor for an on-cell structure touch panel. The on-cell structure touch panel referred to here has the same meaning as that of an on-cell type touch panel display device, which is described later. The transparent conductive member of the present invention is preferably one obtained by the process for producing a transparent conductive member of the present invention.

### Process for Producing Transparent Conductive Member

The process for producing a transparent conductive member of the present invention is not particularly limited; a first layer, a metal layer, and a second layer may be produced by a known method, and examples of a method for forming the first and second layers include a method in which a support or a metal layer is coated therewith and a method involving transfer (lamination). Among them, it is preferable to form them by a coating method. With this embodiment, the cost is excellent.

As a method for forming the metal layer, a method in which coating with a metal-containing ink is carried out and a method involving sputtering can be cited. After a layer is formed by these methods, when patterning is necessary, patterning may be carried out by a known method.

Specific examples of the process for producing a transparent conductive member of the present invention include those below.

A support is coated with a first layer-forming composition, dried as necessary, exposed, and developed as necessary to thus form a first layer. The first layer may further be subjected to a heat treatment.

A metal layer is formed on the first layer by a sputtering method, etc.

The metal layer is coated with a second layer-forming composition, dried as necessary, exposed, and developed as necessary to thus form a second layer. The second layer may further be subjected to a heat treatment or the entirety including the first layer may be subjected to a heat treatment.

A method for applying the first and second layer-forming composition is not particularly limited, and examples include a slit coating method, a spray method, a roll coating method, a spin coating method, a cast coating method, a slit-and-spin method, an inkjet method, and a printing method (flexographic, gravure, screen, etc.). An inkjet method and a printing method are preferable since a composition can be placed only in a necessary location, thus preventing the composition being wasted.

Among them, the first and second layer-forming composition is used suitably in a printing method and an inkjet method, and particularly suitably in a screen printing method and an inkjet method.

Furthermore, before coating a support with the first and second layer-forming composition, a so-called pre-wetting method as described in JP-A-2009-145395 may be applied.

When the first and second layer-forming composition comprises a solvent, it is preferable to carry out drying. As a drying method, a method in which solvent is removed from a coated composition film by means of pressure reduction (vacuum) and/or heating, etc. to thus form a dry coating on a substrate can be cited as a preferred example. Heating conditions when drying are preferably on the order of 70° C. to 130° C. and 30 to 300 seconds.

Coating and drying may be carried out in that order, at the same time, or repeatedly in turn. For example, drying may be carried out after inkjet coating is completely finished, or a support may be heated and drying may be carried out while discharging a composition by means of an inkjet coating method.

Exposure involves generating an acid and/or a polymerization initiating species from a photo-acid generator and/or a photopolymerization initiator using actinic radiation and decomposing an acid-decomposable group by the acid and/or polymerizing an ethylenically unsaturated compound, etc.

As an exposure light source, a low-pressure mercury lamp, a high pressure mercury lamp, an ultra high-pressure mercury lamp, a chemical lamp, an LED light source, an excimer laser generator, etc. may be used, and actinic radiation having a wavelength of at least 300 nm but no greater than 450 nm such as i-line (365 nm), h-line (405 nm), or g-line (436 nm) may preferably be used. The irradiating light may be adjusted as necessary by way of a spectral filter such as a long wavelength cut filter, a short wavelength cut filter, or a band-pass filter.

As exposure equipment, various types of exposure equipment such as a mirror projection aligner, a stepper, a scanner, proximity, contact, a microlens array, a lens scanner, and laser exposure may be used.

The amount of exposure in the exposure step is not particularly limited, but is preferably 1 to 3,000 mJ/cm², and more preferably 1 to 500 mJ/cm².

Exposure may be carried out in a state in which there is an oxygen barrier. Examples of oxygen barrier means include exposing under an atmosphere of nitrogen and providing an oxygen barrier film.

Exposure may be carried out for at least part of the composition, and for example it may be whole face exposure or pattern exposure.

It is also possible to carry out, after exposure, a post-exposure heating treatment: Post Exposure Bake (hereinafter, also called ‘PEB’). The temperature when PEB is carried out is preferably at least 30° C. but no greater than 130° C., more preferably at least 40° C. but no greater than 120° C., and particularly preferably at least 50° C. but no greater than 110° C.

The heating method is not particularly limited, and a known method may be used. Examples include a hotplate, an oven, and an infrared heater.

The heating time is preferably on the order of 1 minute to 30 minutes in the case of a hotplate, and preferably on the order of 20 minutes to 120 minutes in other cases. With this range, it is possible to carry out heating without damaging the substrate or the equipment.

The process for producing a transparent conductive member of the present invention may further comprise, as necessary, a development step of developing the exposed first layer or second layer using a developer.

In the development step, a curable composition that has been patternwise exposed is developed using a solvent or an alkaline developer to thus form a pattern. The developer used in the development step preferably comprises a basic compound. As the basic compound, an aqueous solution of an alkali metal hydroxide such as lithium hydroxide, sodium hydroxide, or potassium hydroxide; an alkali metal carbonate such as sodium carbonate or potassium carbonate; an alkali metal bicarbonate such as sodium bicarbonate or potassium bicarbonate; an ammonium hydroxide such as tetramethylammonium hydroxide, tetraethylammonium hydroxide, tetrapropylammonium hydroxide, tetrabutylammonium hydroxide, benzyltrimethylammonium hydroxide, or choline hydroxide; or sodium silicate, sodium metasilicate, etc. may be used. It is also possible to use as the developer an aqueous solution obtained by adding an appropriate amount of a surfactant or a water-soluble organic solvent such as methanol or ethanol to the above aqueous solution of an alkali.

Preferred examples of the developer include a 0.4 to 2.5 mass % aqueous solution of tetramethylammonium hydroxide.

The pH of the developer is preferably 10.0 to 14.0. The development time is preferably 30 to 500 sec., and the method for development may be any of a liquid-puddle method (puddle method), a shower method, a dip method, etc.

A rinsing step may be carried out after development. In the rinsing step, removal of attached developer and removal of development residue are carried out by washing the substrate with pure water, etc. after development. As a rinsing method, a known method may be used. Examples include shower rinsing and dip rinsing.

With regard to pattern exposure and development, a known method and a known developer may be used. For example, a pattern exposure method and a development method described in JP-A-2011-186398 and JPA-2013-83937 may suitably be used.

The process for producing a transparent conductive member of the present invention may comprise a heat treatment step of subjecting an exposed first layer or second layer to a heat treatment after the exposure described above. Carrying out a heat treatment after exposure enables a cured film having excellent strength to be obtained.

The temperature of the heat treatment is preferably 80° C. to 300° C., more preferably 100° C. to 280° C., and particularly preferably 120° C. to 250° C. With this embodiment, it is surmised that, when a1 and/or a2 is used as Component A, condensation of Component A progresses to an appropriate degree, and the physical properties of a cured film are improved.

Furthermore, the time for the heat treatment is not particularly limited, but it is preferably 1 minute to 360 minutes, more preferably 5 minutes to 240 minutes, and yet more preferably 10 minutes to 120 minutes.

Curing by means of light and/or heat in the process for producing a cured film of the present invention may be carried out continuously or in succession.

When a heat treatment is carried out, the transparency may be improved by carrying it out under an atmosphere of nitrogen.

A heat treatment step may also be carried out after carrying out baking at a relatively low temperature prior to the heat treatment step (post-bake) (addition of a middle-bake step). When a middle-bake is carried out, it is preferable to carry out heating at 90° C. to 150° C. for 1 to 60 minutes, and after that a post-bake is carried out at 120° C. to 300° C.

It is also possible to carry out middle-bake and post-bake heating in multiple stages of three or more stages. Designing the middle-bake and post-bake in this way enables the taper angle of a pattern to be adjusted. The above heating may be carried out by using a known heating method such as a hotplate, an oven, or an infrared heater.

Prior to the post-bake, the whole face of a substrate on which a pattern has been formed is re-exposed to actinic radiation (post-exposure), and then is subjected to a post-bake; it is surmised that initiating species are thereby generated by a condensation reaction of each component itself and/or thermal decomposition of photopolymerization initiator remaining in an exposed area and are made to function as a catalyst for promoting a crosslinking step, thus promoting film curing. The amount of exposure when the post-exposure step is included is preferably 100 to 3,000 mJ/cm², and particularly preferably 100 to 500 mJ/cm².

The process for producing a transparent conductive member of the present invention may comprise a step of forming a known layer other than the above layers. Examples include a step of forming a refractive index-adjusting layer, a protective layer, an insulating layer, an adhesion layer, a pressure-sensitive adhesion layer, etc. A method for forming a layer is not particularly limited, and formation may be carried out by a known method. The position where these layers are formed is preferably a position other than between the first layer and the metal layer and between the metal layer and the second layer.

### Transfer Material

The transfer material of the present invention comprises the layered body for a transparent conductive member of the present invention above a temporary support.

The first and second layers of the layered body for a transparent conductive member of the present invention in the transfer material of the present invention may or may not already be subjected to exposure and development, but from the viewpoint of ease of transfer it is preferable for it to be transferred to a support before carrying out exposure and development.

In the case of this embodiment, it is preferable to carry out exposure and development after the layered body for a transparent conductive member of the present invention, etc. is transferred to a desired substrate using the transfer material of the present invention.

With regard to the transfer material of the present invention, after the second layer is formed on the temporary support, the metal layer is formed, and the first layer is then formed on the metal layer. Transferring the transfer material of the present invention to a support allows the support, the first layer, the metal layer, and the second layer to be formed in that order.

The temporary support preferably has flexibility. It is preferable that when applying pressure or when heating and applying pressure, deformation, shrinkage, or stretching do not occur to a great extent. Examples of such a temporary support include a polyethylene terephthalate film, a cellulose triacetate film, a polystyrene film, and a polycarbonate film, and among them a biaxially stretched polyethylene terephthalate film is particularly preferable.

The thickness of the temporary support is not particularly limited but is preferably 5 to 300 μm, and more preferably 20 to 200 μm.

The temporary support may be transparent or may contain dyed silicon, an alumina sol, a chromium salt, a zirconium salt, etc.

Conductivity may be imparted to the temporary support by a method described in JP-A-2005-221726, etc.

It is preferable to provide the transfer material with a protective peel-off layer (also called a cover film) so as to cover the layered body for a transparent conductive member of the present invention. The protective peel-off layer may be formed from the same material as or a similar material to that of the temporary support, but should be easily separated from an uncured layer. As a material for the protective peel-off layer, for example, a silicone paper or a polyolefin or polytetrafluoroethylene sheet is appropriate.

The thickness of the protective peel-off layer is preferably 1 to 100 μm, more preferably 5 to 50 μm, and particularly preferably 10 to 30 μm. When this thickness is at least 1 μm, the strength of the protective peel-off layer is sufficient and the layer is resistant to tearing, and when it is no greater than 100 μm, the cost of the protective peel-off layer is not high, and the protective peel-off layer is resistant to creasing when laminating.

With regard to the protective peel-off layer, examples of commercially available ones include, but are not limited to, Alphan MA-410, E-200C, and E-501 manufactured by Oji Paper Co., Ltd., a polypropylene film manufactured by Shin-Etsu Film Co., Ltd., and a polyethylene terephthalate film of the PS series such as PS-25 manufactured by Teijin Limited. It is also possible to simply produce one by subjecting a commercially available film to sandblasting.

As the protective peel-off layer, a polyolefin film such as a polyethylene film may be used. A polyolefin film that is used as a protective peel-off layer may suitably be produced by thermally melting starting materials and kneading, extruding, biaxially stretching, casting, or inflating.

Furthermore, the transfer material of the present invention may comprise as necessary an adhesion layer and/or a pressure-sensitive adhesion layer between the temporary support and the layered body for a transparent conductive member or between the layered body for a transparent conductive member and the protective peel-off layer. As an adhesive and a pressure-sensitive adhesive used in the adhesion layer and the pressure-sensitive adhesion layer, known materials may be used.

### Touch Panel and Touch Panel Display Device

The touch panel of the present invention is a touch panel comprising the transparent conductive member of the present invention. Furthermore, the touch panel of the present invention preferably comprises the transparent conductive member of the present invention and at least an insulating layer and/or a protective layer.

The touch panel display device of the present invention is a touch panel display device comprising the transparent conductive member of the present invention, and is preferably a touch panel display device comprising the touch panel of the present invention. The touch panel of the present invention is preferably of any known type such as a resistive film type, a capacitance type, an ultrasonic type, or an electromagnetic induction type. Among them, a capacitance type is preferable.

Examples of the capacitance type touch panel include one disclosed in JP-A-2010-28115 and one disclosed in International Patent Laid-open No. 2012/057165. Examples also include an on-cell type (for example, one described in FIG. 19 of JP-A-2013-168125, those described in FIG. 1 and FIG. 5 of JP-A-2012-89102), an OGS (One Glass Solution) type and a TOL (Touch-on-Lens) type (for example, one described in FIG. 2 of JP-A-2013-54727 and those described in FIG. 2, FIG. 3, FIG. 4, and FIG. 5 of JP-A-2015-15042), and various types of out-cell type (the so called GG, G1 •G2, GFF, GF2, GF1, G1F, etc.).

In accordance with the present invention, there can be provided a layered body for a transparent conductive member having low resistance, high transmittance, and excellent crack resistance, a transfer material having the layered body for a transparent conductive member, a transparent conductive member formed using the layered body for a transparent conductive member, a touch panel and a touch panel display device, and a process for producing a touch panel using the transfer material.

### EXAMPLES

The present invention is further specifically explained by reference to the following Examples. The materials, amount of material used, proportions, processing details, treatment procedure, etc. shown in the Examples below may be modified as appropriate as long as the modifications do not depart from the spirit and scope of the present invention. Therefore, the scope of the present invention should not be construed as being limited to the specific Examples shown below. In addition, ‘parts’ and ‘%’ are on a mass basis unless otherwise specified.

### <Measurement of Refractive Index>

The refractive index at a wavelength of 550 nm of the first layer and the second layer was measured using a VUV-VASE ellipsometer (J. A. Wollam Co., Inc. •Japan) at 25° C.

### Example 1

### Preparation of Dispersion P

A dispersion having the formulation below was prepared, this was mixed with 17,000 parts of zirconia beads (0.3 mmø), and dispersion was carried out using a paint shaker for 12 hours. The zirconia beads (0.3 mmø) were separated by filtration, thus giving dispersion P.

Titanium dioxide (Ishihara Sangyo Kaisha Ltd., product name: TTO-51 (A), average primary particle size: 10 to 30 nm): 1,875 parts
DISPERBYK-111 (BYK-Chemie GmbH-Japan) 30% propylene glycol monomethyl ether acetate (PGMEA) solution: 2,200 parts
Solvent PGMEA (Showa Denko K.K.): 3,425 parts

### <Preparation of First and Second Layer-Forming Composition>

As the first and second layer-forming composition, composition 1 below was prepared.

After a uniform solution was formed by formulating and mixing using the formulation below, it was filtered using a filter made of polyethylene having a pore size of 0.2 μm, thus preparing the first and second layer-forming composition (composition 1) used in Example 1. The solids content of the composition thus obtained was 17.0%.

Solvent EDE (diethylene glycol diethyl ether, Toho Chemical Industry Co., Ltd.): 307.5 parts
Basic compound 11 (compound below, CMTU, Toyo Kasei Kogyo Co., Ltd.): 0.02 parts
Polymer C1: 100.0 parts
Photo-acid generator D1 (compound below): 1.9 parts
Alkoxysilane compound H1 (3-glycidoxypropyltrimethoxysilane, KBM-403, Shin-Etsu Chemical Co., Ltd.): 1.7 parts
Surfactant W1 (perfluoroalkyl group-containing nonionic surfactant, F-554, DIC): 0.08 parts
Dispersion P: 181.7 parts
Compound L1 below: 0.2 parts

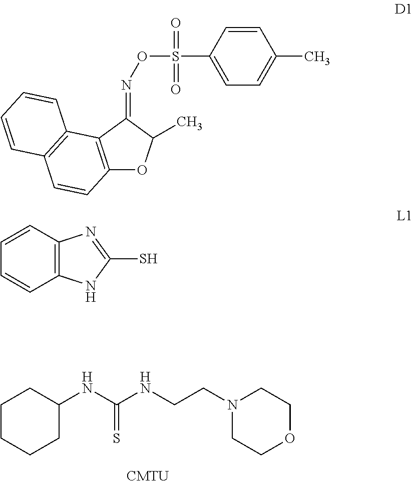

### <Synthesis of MATHF>

Methacrylic acid (86 g, 1 mol) was cooled to 15° C., and camphorsulfonic acid (4.6 g, 0.02 mol) was added thereto. 2-Dihydrofuran (71 g, 1 mol, 1.0 equivalent) was added dropwise to the solution. After stirring for 1 hour, saturated sodium bicarbonate (500 mL) was added, extraction with ethyl acetate (500 mL) was carried out, drying with magnesium sulfate was carried out, insoluble matter was then filtered, vacuum concentration at a temperature of no greater than 40° C. was then carried out, and a yellow oily residue was distilled under vacuum, thus giving 125 g of tetrahydrofuran-2-yl methacrylate (MATHF) as a colorless oily substance, which was a fraction having a boiling point (bp.) of 54° C. to 56° C./3.5 mmHg (yield 80%).

### <Synthesis of Polymer C1>

A mixed solution of propylene glycol monomethyl ether acetate (PGMEA) (120 parts) and a total of 100 parts of tetrahydrofuran-2-yl methacrylate (0.35 molar equivalents), methacrylic acid (0.10 molar equivalents), glycidyl methacrylate (0.45 molar equivalents), and methyl methacrylate (0.10 molar equivalents) was heated at 70° C. under a flow of nitrogen. This mixed solution was added dropwise over 3.5 hours to a mixed solution of V-601 radical polymerization initiator (dimethyl 2,2′-azobis(2-methyl propionate), Wako Pure Chemical Industries, Ltd., 12.0 parts) and PGMEA (80 parts) while stirring. After the dropwise addition was completed, a reaction was carried out at 70° C. for 2 hours, thus giving a PGMEA solution of polymer C1. Further PGMEA was added to thus adjust the solids content concentration to 40 mass %.

The weight-average molecular weight (Mw) measured by gel permeation chromatography (GPC) of the polymer C1 thus obtained was 15,000.

### <Synthesis of D1>

Aluminum chloride (10.6 g) and 2-chloropropionyl chloride (10.1 g) were added to a suspension of 2-naphthol (10 g) in chlorobenzene (30 mL), and a reaction was carried out by heating the mixed liquid at 40° C. for 2 hours. While cooling with ice, a 4N HCl aqueous solution (60 mL) was then added dropwise to the reaction solution, ethyl acetate (50 mL) was added, and separation was carried out. Potassium carbonate (19.2 g) was added to the organic layer, a reaction was carried out at 40° C. for 1 hour, a 2N HCl aqueous solution (60 mL) was added and separation was carried out, the organic layer was concentrated, and crystals were then re-slurried using diisopropyl ether (10 mL), filtered, and dried, thus giving a ketone compound (6.5 g).

Acetic acid (7.3 g) and a 50 mass % hydroxylamine aqueous solution (8.0 g) were added to a suspension in methanol (30 mL) of the ketone compound (3.0 g) thus obtained, and the mixture was heated under reflux. After leaving it to cool, water (50 mL) was added, and the crystals thus precipitated were filtered and washed with cooled methanol, and then dried, thus giving an oxime compound (2.4 g).

The oxime compound (1.8 g) thus obtained was dissolved in acetone (20 mL), triethylamine (1.5 g) and p-toluenesulfonyl chloride (2.4 g) were added while cooling with ice, the mixture was heated to room temperature (25° C.), and a reaction was carried out for 1 hour. Water (50 mL) was added to the reaction solution, and the crystals thus precipitated were filtered, then re-slurried using methanol (20 mL), filtered, and, dried, thus giving compound D1 (the structure above) (2.3 g).

A ¹H-NMR spectrum (300 MHz, CDCl₃) of D1 gave: δ=8.3 (d, 1H), 8.0 (d, 2H), 7.9 (d, 1H), 7.8 (d, 1H), 7.6 (dd, 1H), 7.4 (dd, 1H), 7.3 (d, 2H), 7.1 (d, 1H), 5.6 (q, 1H), 2.4 (s, 3H), 1.7 (d, 3H).

### <Formation of First Layer>

A 75 μm thick PET film (biaxially stretched PET film, Fujifilm Corporation) was coated with composition 1 using a spin coater and dried on a hotplate at 120° C. for 120 seconds (pre-bake). Subsequently, a predetermined pattern was formed by exposure using a ghi-line high-pressure mercury lamp exposure unit with an energy intensity of 20 mW/cm² at 200 mJ/cm². Furthermore, the film thus coated was subjected to thermal treatment in an oven at 140° C. for 60 minutes (post-bake) to thus form a first layer.

### <Formation of Metal Layer>

A 10 nm thick Ag alloy thin film was formed by DC magnetron sputtering (Ag target).

### <Formation of Second Layer>

The metal layer was coated with composition 1 using a spin coater and dried on a hotplate at 120° C. for 120 seconds (pre-bake). Subsequently, a predetermined pattern was formed by exposure using a ghi-line high-pressure mercury lamp exposure unit with an energy intensity of 20 mW/cm² at 200 mJ/cm². Furthermore, the film thus coated was subjected to thermal treatment in an oven at 140° C. for 60 minutes (post-bake) to thus form a second layer, thus giving the transparent conductive member of Example 1.

The thickness of the first layer and the second layer was adjusted by adjusting the thickness of the first-coated film so that the thickness became as described in Table 1 after the post-bake.

### <Evaluation Methods>

Various types of evaluation were carried out using the transparent conductive member and the first and second layer-forming composition of each of the Examples and Comparative Examples by the evaluation methods below. The evaluation results are summarized in Table 1.

### Measurement of Transmittance

The transmittance at a wavelength of 550 nm of the transparent conductive member obtained was measured using a spectrophotometer (MCP-2200, Shimadzu Corporation).

The higher the transmittance, the more preferable it is, and it is more preferably at least 60%.

### Measurement of Resistance

Measurement of resistance (units: Ω/square) of the transparent conductive member obtained was carried out using a LorestaHP MCP-T410 manufactured by Mitsubishi Chemical Corporation.

### Crack Resistance Evaluation

The transparent conductive member obtained (formed on PET film) was cut into a 10 cm×1 cm tape-shaped sample and wound around a columnar rod made of SUS (stainless steel) having a diameter of 3 mm or 5 mm, winding and unwinding around the SUS rod was repeated ten times, and evaluation by means of observation using an optical microscope (20×) was carried out using the evaluation criteria below.

5: no cracks in the case of both 3 mm diameter and 5 mm diameter.
4: no cracks in the case of 5 mm diameter but 1 or 2 cracks in the case of 3 mm diameter.
3: 1 or 2 cracks in the case of both 3 mm diameter and 5 mm diameter.
2: 0 to 2 cracks found in the case of 5 mm diameter but 3 or more cracks found in the case of 3 mm diameter.
1: 3 or more cracks found in the case of both 3 mm diameter and 5 mm diameter.

### Examples 2 to 8, 12 and 13 and Comparative Examples 3 to 5

A transparent conductive member was produced in the same manner as in Example 1 except that the thickness of each layer, the content of Component A in the first and second layers, the presence or absence of a fluorene structure in the first and second layers, and/or the sputtering target for forming the metal layer were changed as in Table 1, and evaluation was carried out in the same manner as in Example 1. The evaluation results are shown in Table 1.

When there was a fluorene structure, as in Examples 2, 4, and 12, in composition 1, 10 parts of the 100.0 parts of polymer C1 was changed to 10 parts of a resin having a fluorene structure (Ogusol PG-100, Osaka Gas Chemicals Co., Ltd.), thus preparing composition 1.

### Example 9

A transparent conductive member was produced in the same manner as in Example 1 except that PC-200 (titanoxane, Matsumoto Fine Chemical Co., Ltd., solids content 31.0%) was used as a TiO₂ dispersion (dispersion P) and the content of Component A in the first and second layers was 70 mass %, evaluation being carried out in the same manner as in Example 1. The evaluation results are shown in Table 1.

### Example 10

A transparent conductive member was produced in the same manner as in Example 1 except that one obtained by diluting titanium tetra normal butoxide (Wako Pure Chemical Industries, Ltd.) to 30 mass % using normal butyl alcohol was used as a TiO₂ dispersion (dispersion P), and the content of Component A in the first and second layers was 70 mass %, evaluation being carried out in the same manner as in Example 1. The evaluation results are shown in Table 1.

### Example 11

A transparent conductive member was produced in the same manner as in Example 1 except that the TiO₂ dispersion (dispersion P) was changed to the ZrO₂ dispersion below, and evaluation was carried out in the same manner as in Example 1. The evaluation results are shown in Table 1.

### <Preparation of ZrO₂ Dispersion>

A dispersion having the formulation below was prepared, this was mixed with 17,000 parts of zirconia beads (0.3 mmø), and dispersion was carried out using a paint shaker for 12 hours. The zirconia beads (0.3 mmø) were separated by filtration, thus giving a dispersion.

UEP-100: zirconium dioxide, Daiichi Kigenso Kagaku Kogyo Co., Ltd., average primary particle size 10 to 15 nm: 1,875 parts
Dispersant (DISPERBYK-111, 30 mass % PGMEA solution): 2,200 parts
Solvent PGMEA (propylene glycol monomethyl ether acetate): 3,425 parts Dispersant
DISPERBYK-111: polymeric dispersant having one or more phosphoric acid ester structure, BYK-Chemie GmbH

### Comparative Example 1

A transparent conductive member was produced in the same manner as in Example 1 except that PC-200 (titanoxane, Matsumoto Fine Chemical Co., Ltd., solids content 31.0%) was used as the TiO₂ dispersion (dispersion P) of composition 1 forming the first layer, one obtained by diluting titanium tetra normal butoxide (Wako Pure Chemical Industries, Ltd.) to 30 mass % using normal butyl alcohol was used as the TiO₂ dispersion (dispersion P) of composition 1 forming the second layer, and the content of Component A in the first and second layers was 90 mass %, evaluation being carried out in the same manner as in Example 1. The evaluation results are shown in Table 1.

### Comparative Example 2

A transparent conductive member was produced in the same manner as in Example 1 except that PC-200 (titanoxane, Matsumoto Fine Chemical Co., Ltd., solids content 31.0%) was used as the TiO₂ dispersion (dispersion P) of composition 1 forming the first layer, the sputtering target forming the metal layer was changed to ITO, one obtained by diluting titanium tetra normal butoxide (Wako Pure Chemical Industries, Ltd.) to 30 mass % using normal butyl alcohol was used as the TiO₂ dispersion (dispersion P) of composition 1 forming the second layer, and the content of Component A in the first and second layers was 90 mass %, evaluation being carried out in the same manner as in Example 1. The evaluation results are shown in Table 1.

### Comparative Example 6

A transparent conductive member was produced in the same manner as in Example 11 except that the content of Component A in the first and second layers was 20 mass %, and evaluation was carried out in the same manner as in Example 1. The evaluation results are shown in Table 1. In this case, the refractive index of the first and second layers did not reach 1.6.

### Example 14

### Negative-Working

A transparent conductive member was produced in the same manner as in Example 1 except that composition 2 was used instead of composition 1, and evaluation was carried out in the same manner as in Example 1. The evaluation results are shown in Table 1.

### <Preparation of Composition 2>

TiO₂ dispersion (dispersion P)
M-1: polyfunctional ethylenically unsaturated compound, mixture of dipentaerythritol hexaacrylate and dipentaerythritol pentaacrylate at a mass ratio of 70:30 (Nippon Kayaku Co., Ltd.)
C-1: IRGACURE CGI-124 (1-[4-(phenylthio)phenyl]-1,2-octanedione-2-(O-benzoyloxime), BASF): 4 mass %
F-1: Megafac F-554 (perfluoroalkyl group-containing nonionic surfactant, DIC): 0.1 mass %

The above components were used, the amounts of TiO₂ dispersion and M-1 were adjusted to give the Component A content described in Table 1, and stirring was carried out for 1 hour using a magnetic stirrer. Subsequently, filtration was carried out using a 0.45 μm membrane filter, thus producing composition 2.

### Example 15

### Use of Negative-Working and Positive-Working in Combination

A transparent conductive member was produced in the same manner as in Example 1 except that the first layer was formed using composition 2 above in the same manner as in Example 14, and evaluation was carried out in the same manner as in Example 1. The evaluation results are shown in Table 1.

### Example 16

### Transfer Material

### <Preparation of Transfer Material>

### Preparation of Photosensitive Transfer Material

A 75 μm thick polyethylene terephthalate film temporary support (PET temporary support) was coated with an undercoat layer coating solution comprising the formulation P1 below using a slit-shaped nozzle and dried, thus forming a peel-off layer. Subsequently, a second layer was formed using composition 1, a metal layer was formed by sputtering in the same manner as in Example 1, and a first layer was formed using composition 1, thus forming a layered body.

The peel-off layer having a dry thickness of 2.0 μm and the layered body layer for a transparent conductive member were provided as described above on the PET temporary support, and subjected to compression bonding to a glass substrate using a hot roll at 140° C., thus producing a sample having a layered structure of glass substrate/first layer/metal layer/second layer

The sample was subjected to a post-bake at 140° C. for 60 minutes, thus giving a transparent conductive member. The transparent conductive member thus obtained was evaluated in the same manner as in Example 1. The evaluation results are shown in Table 1.

### Formulation P1 of Coating Solution for Undercoat Layer

Polyvinyl alcohol (PVA-105, Kuraray Co., Ltd.): 3.0 parts
Carboxymethylcellulose (TC-5E, Shin-Etsu Chemical Co., Ltd.): 0.15 parts
Surfactant 2 (Surflon S-131, AGC SEIMI CHEMICAL CO., LTD.): 0.01 parts
Distilled water: 524 parts
Methanol: 429 parts

TABLE 1

| | First layer | | | | | Metal layer | | | |
|---|---|---|---|---|---|---|---|---|---|
| | | | Average | Component A | | | Average | Second layer | |
| | | Refractive | thickness | content | Fluorene | Type of | thickness | | Refractive |
| | Material | index | (nm) | (mass %) | structure | metal | (nm) | Material | index |
| Ex. 1 | TiO₂ | 1.8 | 50 | 60 | No | Ag | 10 | TiO₂ | 1.8 |
| Ex. 2 | TiO₂ | 1.8 | 50 | 50 | Yes | Ag | 10 | TiO₂ | 1.8 |
| Ex. 3 | TiO₂ | 1.6 | 50 | 20 | No | Ag | 10 | TiO₂ | 1.6 |
| Ex. 4 | TiO₂ | 1.9 | 50 | 60 | Yes | Ag | 10 | TiO₂ | 1.9 |
| Ex. 5 | TiO₂ | 1.8 | 50 | 60 | No | Ag | 5 | TiO₂ | 1.8 |
| Ex. 6 | TiO₂ | 1.8 | 50 | 60 | No | Ag | 20 | TiO₂ | 1.8 |
| Ex. 7 | TiO₂ | 1.8 | 10 | 60 | No | Ag | 10 | TiO₂ | 1.8 |
| Ex. 8 | TiO₂ | 1.8 | 100 | 60 | No | Ag | 10 | TiO₂ | 1.8 |
| Ex. 9 | TiO₂ | 2.0 | 50 | 70 | No | Ag | 10 | TiO₂ | 2.0 |
| | oligomer | | | | | | | oligomer | |
| Ex. 10 | Ti(OBu)₄ | 1.7 | 50 | 70 | No | Ag | 10 | Ti(OBu)₄ | 1.7 |
| Ex. 11 | ZrO₂ | 1.65 | 50 | 60 | No | Ag | 10 | ZrO₂ | 1.65 |
| Ex. 12 | TiO₂ | 1.8 | 50 | 50 | Yes | AgPd: 1.0% | 10 | TiO₂ | 1.8 |
| Ex. 13 | TiO₂ | 1.8 | 40 | 60 | No | Ag | 10 | TiO₂ | 1.8 |
| Ex. 14 | TiO₂ | 1.8 | 50 | 60 | No | Ag | 10 | TiO₂ | 1.8 |
| Ex. 15 | TiO₂ | 1.8 | 50 | 60 | No | Ag | 10 | TiO₂ | 1.8 |
| Ex. 16 | TiO₂ | 1.8 | 50 | 60 | No | Ag | 10 | TiO₂ | 1.8 |
| Comp. | TiO₂ | 2.1 | 50 | 90 | No | Ag | 10 | TiO₂ | 2.1 |
| Ex. 1 | oligomer | | | | | | | oligomer | |
| Comp. | TiO₂ | 2.1 | 50 | 90 | No | ITO | 10 | TiO₂ | 2.1 |
| Ex. 2 | oligomer | | | | | | | oligomer | |
| Comp. | TiO₂ | 1.55 | 50 | 20 | No | Ag | 20 | TiO₂ | 1.55 |
| Ex. 3 | | | | | | | | | |
| Comp. | TiO₂ | 1.8 | 400 | 60 | No | Ag | 10 | TiO₂ | 1.8 |
| Ex. 4 | | | | | | | | | |
| Comp. | TiO₂ | 1.8 | 5 | 60 | No | Ag | 10 | TiO₂ | 1.8 |
| Ex. 5 | | | | | | | | | |
| Comp. | ZrO₂ | 1.55 | 50 | 20 | No | Ag | 20 | TiO₂ | 1.55 |
| Ex. 6 | | | | | | | | | |

| | Second layer | | | | | |
|---|---|---|---|---|---|---|
| | Average | Component A | | Evaluation result | | |
| | thickness | content | Fluorene | | Resistance | Crack |
| | (nm) | (mass %) | structure | Transmittance | (Ω/square) | resistance |
| Ex. 1 | 50 | 60 | No | 90% | 8 | 5 |
| Ex. 2 | 50 | 60 | Yes | 92% | 8 | 5 |
| Ex. 3 | 50 | 20 | No | 85% | 8 | 5 |
| Ex. 4 | 50 | 60 | Yes | 87% | 8 | 5 |
| Ex. 5 | 50 | 60 | No | 92% | 30 | 5 |
| Ex. 6 | 50 | 60 | No | 75% | 5 | 5 |
| Ex. 7 | 10 | 60 | No | 80% | 8 | 5 |
| Ex. 8 | 100 | 60 | No | 75% | 8 | 4 |
| Ex. 9 | 50 | 70 | No | 70% | 8 | 3 |
| Ex. 10 | 50 | 70 | No | 70% | 8 | 3 |
| Ex. 11 | 50 | 60 | No | 85% | 8 | 5 |
| Ex. 12 | 50 | 50 | Yes | 91% | 8 | 5 |
| Ex. 13 | 60 | 60 | No | 86% | 8 | 5 |
| Ex. 14 | 50 | 60 | No | 88% | 8 | 5 |
| Ex. 15 | 49 | 60 | No | 88% | 8 | 5 |
| Ex. 16 | 50 | 60 | No | 90% | 8 | 5 |
| Comp. | 50 | 90 | No | 85% | 8 | 1 |
| Ex. 1 | | | | | | |
| Comp. | 50 | 90 | No | 85% | 50 | 1 |
| Ex. 2 | | | | | | |
| Comp. | 50 | 20 | No | 55% | 8 | 5 |
| Ex. 3 | | | | | | |
| Comp. | 400 | 60 | No | 55% | 8 | 5 |
| Ex. 4 | | | | | | |
| Comp. | 5 | 60 | No | 90% | 8 | 1: faild to |
| Ex. 5 | | | | | | form film |
| Comp. | 50 | 20 | No | 55% | 8 | 5 |
| Ex. 6 | | | | | | |

The ‘AgPd: 1.0%’ described in Table 1 is a silver alloy containing 1.0 mass % of palladium.

What is claimed is:

1. A layered body for a transparent conductive member comprising, in order, a first layer, a metal layer, and a second layer,
the first and second layers each comprising an organic resin and, as Component A, at least one type selected from the group consisting of a1 to a3 below,
the first and second layers each having a refractive index of 1.6 to 2.0 for light having a wavelength of 550 nm,
the first and second layers each having an average thickness of 10 to 100 nm,
the metal layer comprising silver and/or copper, and
the metal layer having an average thickness of 5 to 50 nm,
a1: an alkoxy group-containing titanium compound and/or zirconium compound,
a2: a titanoxane, zirconoxane, and/or titanoxane-zirconoxane condensation product having at least one alkoxy group directly connected to a titanium atom or a zirconium atom,
a3: a titanium atom- and/or zirconium atom-containing metal oxide.

2. The layered body for a transparent conductive member according to claim 1, wherein it has a transmittance for light having a wavelength of 550 nm of at least 60%.

3. The layered body for a transparent conductive member according to claim 1, wherein Component A in the first and second layers has a content by mass of at least 20 mass % but no greater than 70 mass %.

4. The layered body for a transparent conductive member according to claim 1, wherein the organic resin comprises a resin having a fluorene ring structure.

5. The layered body for a transparent conductive member according to claim 1, wherein the organic resin comprises an acrylic resin.

6. The layered body for a transparent conductive member according to claim 1, wherein the metal layer comprises silver.

7. The layered body for a transparent conductive member according to claim 1, wherein the metal layer comprises a silver alloy.

8. The layered body for a transparent conductive member according to claim 1, wherein the first and second layers each comprise at least a1 as Component A.

9. The layered body for a transparent conductive member according to claim 1, wherein the first and second layers each comprise at least a3 as Component A.

10. A transfer material comprising the layered body for a transparent conductive member according to claim 1 above a temporary support.

11. A process for producing a touch panel, comprising forming a touch electrode using the transfer material according to claim 10.

12. A transparent conductive member comprising a cured material formed by curing the layered body for a transparent conductive member according to claim 1.

13. A touch panel comprising the transparent conductive member according to claim 12.

14. A touch panel display device comprising the transparent conductive member according to claim 12.
